(19) United States
(12) Patent Application Publication
(10) Pub. No.: US 2025/0043615 A1
(43) Pub. Date: Feb. 6, 2025

(54) System and Method for Implementing a Rules Optimizer at a Facility Associated with Freight

(71) Applicant: THE CHAMBERLAIN GROUP LLC, OAK BROOK, IL (US)

(72) Inventors: Jessica Trail, Darien, IL (US); Rong Li, Chicago, IL (US); Jeff Schulze, Hortonville, WI (US); Brett Lindstrom, Cedarburg, WI (US); Luke Krombach, Glenview, IL (US); Melissa O'Keefe, Grayson, GA (US)

(21) Appl. No.: 18/923,059

(22) Filed: Oct. 22, 2024

Related U.S. Application Data
(63) Continuation-in-part of application No. 17/973,246, filed on Oct. 25, 2022.
Application No. 17/973,246 is a continuation of application No. 17/005,710, filed on Aug. 28, 2020, now Pat. No. 11,492,838.
(60) Provisional application No. 62/914,745, filed on Oct. 14, 2019.
(60) Provisional application No. 62/900,569, filed on Sep. 15, 2019.

(51) Int. Cl. E05F 15/73; B65G 69/28

(52) U.S. Cl. CPC E05F 15/73; B65G 69/2811; E05Y 2400/30; E05Y 2400/44; E05Y 2400/45; E05Y 2400/856; E05Y 2900/11; E05Y 2900/40

(57) ABSTRACT

A rules optimizer for optimizing one or more operations at a facility, the rules optimizer configured to: receive an event update associated with an upcoming operation scheduled at the facility; generate a set of potential scheduling decisions associated with the upcoming operation, wherein generating the set of potential scheduling decisions is based at least in part on historical data stored at the non-transitory computer-readable storage medium, and wherein generating the set of potential scheduling decisions is based at least in part on the received event update; select a scheduling decision from the set of potential scheduling decisions; and update a schedule associated with the facility in view of the selected scheduling decision; and transmit a notification to a vehicle providing information associated with the updated schedule, the vehicle adjusting an action in response to the updated schedule.

### FIELD

The present disclosure relates generally to systems and methods of improving facility access and efficiency for freight loading and unloading.

### BACKGROUND

Movable barrier operators of various kinds are used to control the opening and closing of gates, doors, and other barriers that permit access to secured premises and/or enclosed spaces. Example movable barrier operators include gate operators, rolling shutter operators, garage door operators, and the like.

Commercial and industrial facilities may have a fence or wall around the facility and one or more gates or other barriers for controlling access to the facility. Examples of such facilities include warehouses, factories, logistic centers, and assembly plants. Typically, when a vehicle such as a semi-trailer truck arrives at such a facility, the vehicle operator must “check in” at a gate before the vehicle is permitted to enter the facility. If the vehicle is authorized, an employee at the gate will open the gate. This check-in process may be time consuming, resulting in increased vehicle idle time at the perimeter of the facility. Increased idle time reduces the efficiency of both the vehicle operator and the facility.

Upon check-in, a vehicle may be directed by the employee at the gate to a loading dock to load or unload freight. In some instances, the loading or unloading of freight may be delayed upon arrival of the vehicle at the loading dock. Such a delay may occur, for example, when facility personnel are not available at the loading dock at the time the vehicle arrives at the loading dock. Thus, conventional approaches for logistics at a facility may result in idle time of vehicles at the gate of the facility as well as detention time and/or dwell time within the facility. As can be appreciated, facility inefficiencies such as the foregoing-mentioned idle time, detention time and dwell time may result in lost time to carriers (or vehicle drivers/operators) and additional cost to shippers or receivers.

Another problem with conventional approaches is that there is often no way for a trucking company to independently confirm the time a truck has arrived or departed from a facility. The employee of the facility such as a spotter or a guard at the entry/exit gate may keep a paper record of the trucks entering and exiting the facility, but the paper record may be lost or tampered with. A related problem encountered by trucking companies is that the contents of trailers are often tracked using paper bills of lading, which creates delays and difficulties in reconciliation including freight tracking and billing.

Accordingly, improved systems and methods are desired in the art. In particular, systems and methods which provide optimized and efficient use of a facility would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a rules optimizer for optimizing one or more operations at a facility is provided. The rules optimizer includes a non-transitory computer-readable storage medium storing machine-executable instructions; and a processor in communication with the computer-readable storage medium, wherein the instructions, when executed by the processor, are configured to cause the rules optimizer to: receive an event update associated with an upcoming operation scheduled at the facility; generate a set of potential scheduling decisions associated with the upcoming operation, wherein generating the set of potential scheduling decisions is based at least in part on historical data stored at the non-transitory computer-readable storage medium, and wherein generating the set of potential scheduling decisions is based at least in part on the received event update; select a scheduling decision from the set of potential scheduling decisions; update a schedule associated with the facility in view of the selected scheduling decision; and transmit a notification to a vehicle providing information associated with the updated schedule, the vehicle adjusting an action in response to the updated schedule.

In accordance with another embodiment, a computer-implemented method for optimizing one or more operations at a facility is provided. The computer-implemented method includes receiving, at a processor of a rules optimizer, an event update associated with an upcoming operation scheduled at the facility, the upcoming operation including a loading or unloading operation associated with freight at a first vehicle; generating, by the processor, a set of potential scheduling decisions associated with the upcoming operation, wherein generating the set of potential scheduling decisions is based at least in part on historical data stored at a non-transitory computer-readable storage medium in communication with the processor, and wherein generating the set of potential scheduling decisions is based at least in part on the received event update; selecting a scheduling decision from the set of potential scheduling decisions, wherein selecting the scheduling decision comprises: scoring each scheduling decision from the set of potential scheduling decisions; and selecting a highest scoring scheduling decision; and updating a schedule associated with the facility in view of the selected scheduling decision; and transmitting a notification to a vehicle providing information associated with the updated schedule, the vehicle adjusting an action in response to the updated schedule.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is an example schematic diagram showing a movable barrier operator for controlling access to a facility, dock door operators for controlling access to loading docks of the facility, and a remote server computer for controlling the movable barrier operator and the dock door operator in accordance with embodiments of the present disclosure;

FIG. 2 is an example block diagram of the movable barrier operator of FIG. 1 in accordance with embodiments of the present disclosure;

FIG. 3 is an example block diagram of the remote server computer of FIG. 1 in accordance with embodiments of the present disclosure;

FIG. 4 is an example block diagram of the user device of FIG. 1 in accordance with embodiments of the present disclosure;

FIG. 5 is an example block diagram of a remote server computer of FIG. 1 in accordance with embodiments of the present disclosure;

FIG. 6 is an example schedule of a facility of FIG. 1 in accordance with embodiments of the present disclosure;

FIG. 7 is an example flow chart of a method of generating a scheduling decision for a facility of FIG. 1 in accordance with embodiments of the present disclosure;

FIG. 8 is an example flow chart of a method of tuning a rule optimizer between different facilities in accordance with embodiments of the present disclosure; and

FIG. 9 is a schematic of a loading dock facility in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false for not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, embodiments of the present disclosure described herein are directed to systems, components, and methods of using a facility to perform operations in an efficient manner. In particular, embodiments are directed to a rule optimizer that interacts with a rule generator to make scheduling decisions that best utilize the capabilities of a facility to maximize efficiency and reduce wasted time.

In an embodiment, operations at the facility are scheduled, at least in part, based on scheduling decisions determined by a rule generator. The rule generator may set the schedule based on a set of operations to be conducted in a scheduling time period (e.g., that day). The rule generator may organize the set of operations over a period of time (i.e., schedule the set of operations). For example, the set of operations can include loading and unloading freight from vehicles at loading docks. The rule generator can arrange a schedule that assigns the vehicles to particular docks in particular time slots. The assignment can be based on scheduled arrival times, expected freight, etc. After arriving at the facility, the vehicles are provided with instructions that assign each of the vehicles to their respective dock.

Over time, it may be necessary to adjust the schedule. For example, some vehicles may arrive late. Other vehicles may take longer than expected to load or unload. Yet other vehicles may include different freight than expected. All of these instances (and more) require adaptation and modification to the schedule in order to maintain an efficient facility operation.

In accordance with an embodiment, a rules optimizer can be implemented to optimize the schedule. In some instances, the rule optimizer can interact with the rule generator to update the schedule. In other instances, the rule optimizer can operate independent of the rule generator and generate and/or update the schedule by itself. The rule optimizer can consider historical data, current data, and future (anticipated) data to update the schedule and thereby increase facility efficiency. Historical data can include data associated with prior events. For example, historical data can include delay information, time information, vehicle information, etc. associated with past operations. The rule optimizer can utilize the historical data when making scheduling decisions. By way of example, when a particular shipping route exhibits a pattern of delays, the rule optimizer may update the schedule to anticipate such delays. Current data can include data associated with current events. For example, current data can include current weather conditions, current traffic conditions, current vehicle location, etc. The current data can be used to update the schedule in real time. Future data can include future expected (anticipated) data. For instance, approaching inclement weather (e.g., winds, rain, snow, etc.) can cause future delays and issues with facility usage. The rule optimizer can analyze the future data and generate predictions to accommodate and/or overcome the predictions.

The rule optimizer can generate a set of potential scheduling decisions (e.g., scheduling options) and select between the set of potential scheduling decisions. For example, the rule optimizer can assign a weight to each of the potential scheduling decisions. The rule optimizer can then select the decision with the highest weight. The weight may be determined in view of facility-specific settings and functionality or in view of global (universal) priority schemas. By way of example, the facility manager can select between different priorities which can be considered, e.g., during the weighting process, to affect the selected scheduling decision. The priorities may be selected at a prioritizer. The prioritizer may be binary (e.g., on v. off) or incrementally adjustable such that each priority can be assigned a relative weight. By way of non-limiting example, the priorities can include cost, time, special considerations, etc.

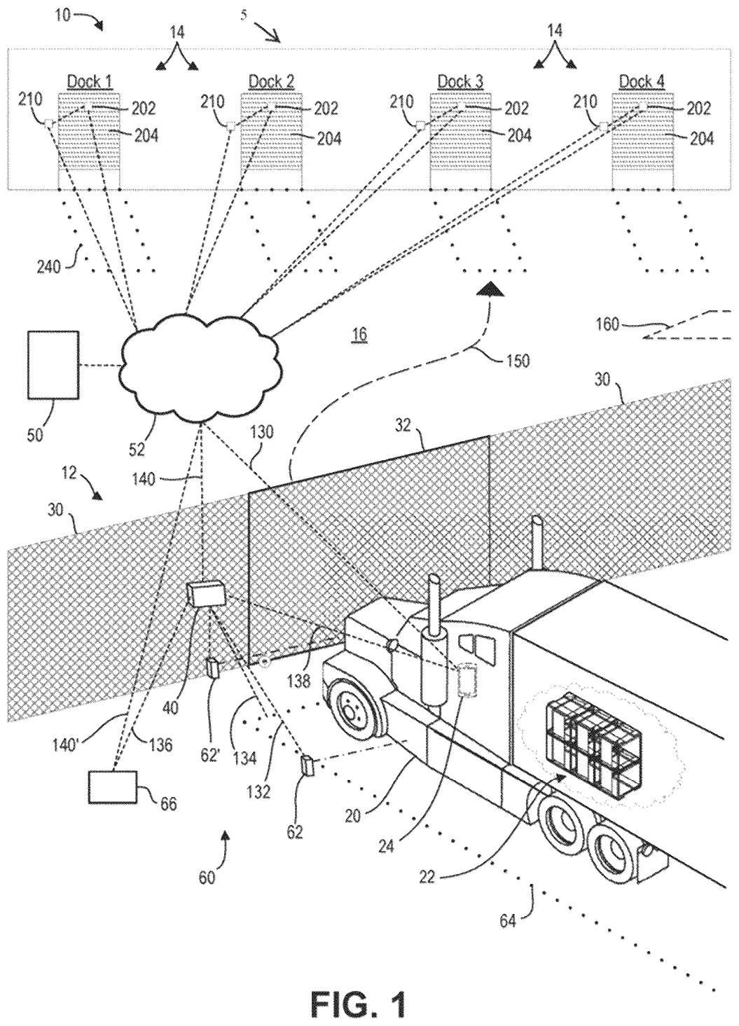

Referring now to FIG. 1, a facility 10 includes a perimeter barrier 12 that inhibits access to a secured premises 16. The facility 10 may be, for example, a warehouse, a shipping facility, an assembly plant, and the like. The facility 10 may include plurality of loading docks 14 located within the secured premises 16 of the facility 10. A vehicle 20, which may be a tractor-trailer, flatbed truck, or cargo van as some examples, accesses the loading docks 14 via a movable barrier 32, such as a gate, of the perimeter barrier 12 to load or unload freight 22 at the loading docks 14. As discussed in greater detail below, a user (e.g., the operator) of the vehicle 20 may operate one or more user devices 24 upon arrival at the perimeter barrier 12 to initiate opening of the movable barrier 32, and may operate the user device 24 upon arrival at a loading dock 14 to initiate opening of a movable barrier of the loading dock 14, such as a loading dock door 204.

The perimeter barrier 12 shown in FIG. 1 is in the form of a chain link fence having fixed barrier portions 30 and the movable barrier 32 that shifts relative to the fixed barrier portions 30. The movable barrier 32 shown in FIG. 1 may include rollers that travel along a track as the movable barrier 32 is shifted relative to the fixed barrier portions 30. In other embodiments, the movable barrier 32 may be include a swinging gate or door, a sectional garage door or one-piece “California” garage door, a roller door, a movable arm, tire spikes, or another suitable barrier for controlling access to the secured premises 16.

The facility 10 includes a system 5 for selectively permitting access to the facility 10. The system 5 includes a movable barrier operator 40, such as a gate operator, operatively connected to the movable barrier 32 to move the movable barrier 32 between a closed position and an open position. The movable barrier operator 40 may include or be in communication with an access control apparatus such as a telephone entry system-like panel that is configured to manage or control operation of the movable barrier operator 40. The access control apparatus may be configured with audio and/or video communication hardware such as a microphone, speaker, and/or camera such that the driver/operator of the vehicle may request access from an individual, e.g. a security guard, who is remote from the entrance or facility 10. Additionally or alternatively, the access control apparatus may include a credential receiver (e.g., biometric scanner, numeric keypad, card reader, etc.) that may authenticate, authorize or verify a user device 24 or user thereof. The system 5 includes a remote server computer 50 configured to communicate with the movable barrier operator 40 over a network 52. The remote server computer 50 may include one or more computers connected to provide operability as discussed below.

The remote server computer 50 is also configured to communicate with one or more sensors, indicated generally at 60. The sensors 60 may be located at the perimeter barrier 12 of the facility 10. In one embodiment, the sensors 60 communicate with the movable barrier operator 40, which communicates sensor data to the remote server computer 50. The communications between the sensors 60 and the movable barrier operator 40 may include wired and/or wireless approaches. In one embodiment, signals are communicated between the particular sensor 60 and the movable barrier operator 40 via another device (e.g., a proxy or a router).

The sensors 60 may be a presence detector that is configured to detect presence of a vehicle 20. For example, the sensors 60 may include a photo beam system 62 and/or a loop detector 64. Other presence sensors, indicated generally at 66, can include one or more of a passive infrared detector, camera, a radio frequency receiver, a short-range (e.g., Bluetooth) receiver, a magnetic detector, a light or sound-based time-of-flight sensor, a capacitance detector, sound detector, and an optical detector (e.g., a camera). The sensors 60 may inform the movable barrier operator 40 and/or the remote server computer 50 of the presence of a vehicle 20 at the movable barrier 32 of the facility 10.

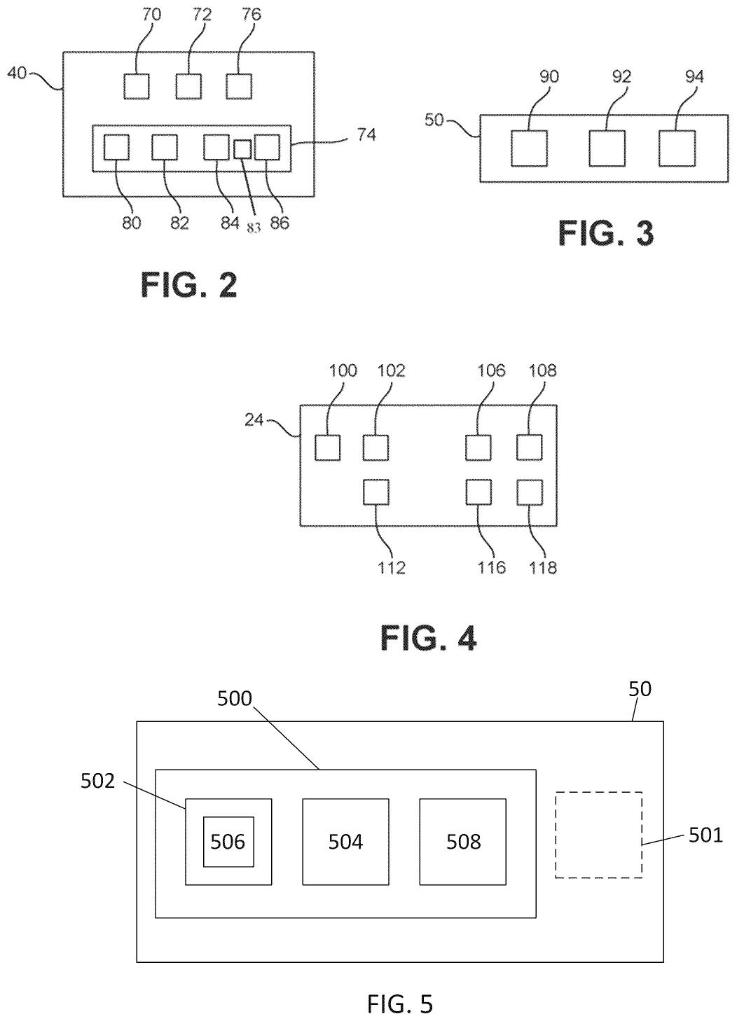

Referring to FIG. 2, the movable barrier operator 40 may include a motor 70, a memory 72, and communication circuitry 74. The movable barrier operator 40 may further include processing circuitry 76 that is operatively coupled to one or more of the motor 70, the memory 72, and the communication circuitry 74. The motor 70 is configured to be connected to a movable barrier (e.g., movable barrier 32) to move the movable barrier between open and closed positions. The memory 72 may store identification and security (e.g. rolling code) information for authorized remote controls.

The communication circuitry 74 may be configured to receive wired and/or wireless communications from a local device (such as a local transmitter or local sensor) and/or a remote device (such as the remote server computer 50). In this way, the communication circuitry 74 may include a radio frequency signal receiver or transceiver 80 that may receive a command signal from a radio frequency signal transmitter to change the state of the movable barrier 32.

The communication circuitry 74 may further include a network interface 82. The network interface 82 may be configured to communicate with the remote server computer 50 over the network 52, as shown in FIG. 1. The network interface 82 may communicate with the network 52 via wired and/or wireless approaches, such as a wireless gateway or access point, e.g. a Wi-Fi router. The network interface 82 may receive a state change command from the remote server computer 50 (e.g., via the network 52) to cause the movable barrier operator 40 to change the state (e.g., a closed position to an open position or vice versa) of the movable barrier 32. The network interface 82 may also communicate information to the remote server computer 50. Such information may include information identifying the vehicle 20, a user (e.g., driver and/or passenger) associated with the vehicle 20, the freight 22 of the vehicle 20, information pertaining to the movable barrier 32, information pertaining to one or more sensors 60 associated with the movable barrier 32, or any combination thereof. The communication circuitry 74 may also include a long-range wireless transceiver 83 that may communicate with other devices. For example, the communication circuitry may receive communications from one or more devices such as sensors having WiMax or LoRa-based communication operability, such as a V2X (vehicle to anything) sensor. Such sensors may be mounted, for example, to a stoplight or stop sign at an intersection near the facility 10 and may detect a beacon signal from the user device 24 or other component of the vehicle. The movable barrier operator 40 may thereby be able to determine the vehicle 20 is nearby, and may further be able to communicate such information to the remote server computer 50.

The communication circuitry 74 may further include a short-range wireless transceiver 84. In one example, the short-range wireless transceiver 84 may be configured to receive a check-in signal directly from the user device 24 over a short-range wireless protocol, such as Bluetooth, near-field communication (NFC), or infrared. The communication circuitry 74 may also include a wired communication interface 86 for communicating with one or more devices (e.g., a local sensor 60).

Referring to FIG. 3, the remote server computer 50 may facilitate operation of one or more movable barrier operators 40 at the facility 10. For example, the remote server computer 50 may communicate control commands (e.g., open, close, start, stop, etc.) to the movable barrier operator 40 (see FIG. 1) of the facility 10. Additionally or alternatively, the remote server computer 50 may communicate control commands to one or more dock door operators 202 at the loading docks 14 to operate associated loading dock doors 204, as discussed in greater detail below. To facilitate operation of the movable barrier operator 40, the remote server computer 50 includes a network or communication interface 90 configured to communicate via the network 52 with movable barrier operators 40 at the facility 10. The communication interface 90 is further configured to communicate with the user device 24 via the network 52.

The remote server computer 50 also includes a non-transitory, computer-readable medium such as a memory 92 for storing information. For example, the memory 92 may store facility information such as facility identification, facility location, facility contact information, facility history information, etc. Schedule information, such as authorized arrival times and departure times for vehicles 20, may also be stored in the memory 92. The memory 92 may also store transport logs, which may include actual arrival times and/or actual departure times, which are recorded when the user utilizes the user device 24 to operate the movable barrier operator 40. The ability of the system 5 to determine actual arrival and departure times based on operation of the movable barrier operator provides independent verification and improved freight tracking accuracy over relying on paper records. The memory 92 may also store barrier operator information, which may include the times of operation of a given barrier operator, a number of actuation events for a given barrier operator (e.g., lifetime actuation events, or actuation events since a last maintenance operation). The memory 92 may store information from the sensors 60 at a given facility 10 such as presence detections, times of presence detections, and/or estimated accuracy of detections. The memory 92 may also store user information, which may include user identification information, account information, contact information, user histories, still or moving images of the user, vehicle, etc., and/or user notes. The memory 92 may further store freight information such as freight identifiers, freight tracking information, freight notes, bills of lading, and/or packaging slips. The memory 92 may also store loading dock information, such as the status of dock door operators 202, the position of a truck restraint 226 (see FIG. 5), height of a dock leveler 224, and/or identifications of sensors and/or configurable devices at a given loading dock.

The remote server computer 50 also includes a processor 94 that is operatively coupled to the communication interface 90 and the memory 92. The processor 94 may determine whether a first condition is satisfied (e.g., whether the vehicle 20 has arrived at the facility 10), and may further determine whether a second condition is satisfied (e.g., whether the vehicle 20 is authorized to access the facility 10 at that time), as discussed in greater detail below. Upon satisfaction of both conditions, the processor 94 may communicate a control command, via the communication interface 90, to an operator (e.g., movable barrier operator 40 and/or dock door operator 202) at the facility 10 to operate a movable barrier. In other instances the remote server computer 50 may, alone or in conjunction with another apparatus, permit access to the facility 10 based on satisfaction of a single condition or a plurality of conditions. As another example, the remote server computer 50 communicates a token to the user device 24 and the user device 24 communicates a control command, including the token, to the movable barrier operator 40 to cause the movable barrier operator 40 to change the state of the movable barrier 32. Furthermore, the processor 94 may communicate a configuration command to affect a configuration of one or more loading dock devices at the loading docks 14, as discussed in greater detail with respect to FIG. 4.

The remote server computer 50 may take a variety of embodiments. For example, the remote server computer 50 may be an “off-site” server computer that is not located at the facility 10. In another embodiment, the remote server computer 50 is an “on-site” server computer that is located at the facility 10. For example, the remote server computer 50 may be located in an office of the facility 10.

Referring to FIG. 4, an example of the user device 24 for use by an occupant of the vehicle 20 is shown. The user device 24 may include one or more of a user input 100, such as a touch screen, keypad, speaker, microphone, heads-up display, augmented reality display, and communication circuitry 102 for communicating with a remote device (e.g., remote server computer 50). The communication circuitry 102 may include a long-range wireless communication interface, such an interface that communicates with cellular networks (3G, 4G, 4G LTE, 5G), WiMax networks, and/or LoRa networks as some examples. The communication circuitry 102 may also include a short-range wireless communication interface, such as an interface that communicates using Bluetooth, Wi-Fi, and/or ZigBee. The user device 24 may also include a memory 106, a power source 108 such as a battery or an electrical power source in a vehicle, location circuitry 112 such as a global navigation satellite system (e.g., GPS) transceiver, and an optical device 116 such as a camera and/or a barcode scanner. The user device 24 may further include a processor circuit 118 operatively coupled to the other components of the user device 24 for controlling the operation thereof.

In one aspect, the user device 24 may be a personal user device, such as a smartphone, tablet computer, personal computer, or wearable device (e.g., smartwatch). As another example, the user device 24 is a vehicle-integrated user device, such as a human machine interface of the vehicle 20. Examples of human machine interfaces include a vehicle center stack, a dashboard display, a navigation unit, a telematics unit, an infotainment unit, and a heads-up display system.

Referring again to FIG. 1, an arrival or check-in process will now be described. Upon arriving at the facility 10 (e.g., at the perimeter barrier 12 of the facility 10), at least a portion of a check-in process may be performed at the user device 24. During the check-in process, a check-in communication 130 is transmitted from the user device 24 to the remote server computer 50 via the network 52. According to one aspect, the check-in process is initiated when a user, such as the vehicle operator, opens and/or controls an application of the user device 24. For example, the vehicle occupant may provide an input at the user input 100, which may include a touch screen, to request a change of state of the movable barrier 32. The processor circuit 118 is configured to cause the communication circuitry 102 to communicate the check-in communication 130 to the remote server computer 50. In this way, the user may manually affect transmission of the check-in communication 130 from the user device 24 upon arriving at the facility 10.

According to another aspect, the user device 24 may automatically affect transmission of the check-in communication 130 from the user device 24. In this aspect, transmission of the check-in communication 130 may be effected in response to the processor circuit 118 determining (e.g., via location circuitry 112) that the user device 24 is at a predetermined geolocation or proximity relative to the facility 10 (e.g., at the movable barrier 32). As another example, the user device 24 may automatically affect transmission of the check-in communication upon the user device 24 receiving a beacon signal or light pattern from the movable barrier operator 40 or, as previously mentioned, an access control apparatus that is associated or in communication with the movable barrier operator 40.

In one embodiment, the check-in communication 130 is communicated directly to the remote server computer 50 via the network 52. In another approach, the check-in communication 130 is communicated to the movable barrier operator 40 (via signal 138), which relays the check-in communication 130 to the remote server computer 50 via the network 52. In such an approach, the movable barrier operator 40 may function as a terminal for relaying information (e.g., check-in information) to the remote server computer 50.

The check-in communication 130 may include location information. For example, the check-in communication 130 may include a location associated with the vehicle 20 (e.g., as informed by the location circuitry 112 of the user device 24). Additionally or alternatively, the check-in communication 130 may include a location of a movable barrier 32 or movable barrier operator 40 associated with the location of the vehicle 20.

Additionally or alternatively, the check-in communication 130 may include a check-in identifier. The check-in identifier may include information pertaining to at least one of the user, the vehicle 20, the user device 24, and freight 22 transported (or to be transported) by the vehicle 20. Information pertaining to the user may include a user identifier (e.g., name, employer, user ID). Information pertaining to the vehicle 20 may include a vehicle identifier (which may include a tractor identifier and/or a trailer identifier), vehicle owner information, vehicle schedule information (e.g., prior schedule information and/or future schedule information), and/or vehicle characteristic. A vehicle characteristic may include, for example, a height of the vehicle 20, a height and/or type of a rear impact guard of the vehicle 20, and/or an identifier associated with the vehicle 20. Information pertaining to the user device 24 may include a globally unique ID of the user device 24. Freight-related information may include a name and/or address of the shipper, a name and/or address of the recipient, dates (e.g., pickup and/or delivery dates), locations (e.g., pickup and/or delivery locations), purchase orders or reference numbers, description of the freight (e.g., number of shipping units, dimensions, weight, materials, packaging, freight class, hazardous material designation, storage requirements such as temperature or environmental requirements, etc.), instructions, or combinations thereof. Other freight-related information may include stock keeping unit (SKU) and/or food lot numbers.

The check-in communication 130 may include information relating to image data such as one or more of pictures or video captured, for example, by a sensor 60 or by the optical device 116 of the user device 24. The pictures and/or video may include pictures and/or video of an identifier of the vehicle 20 such as a trailer number, a license plate, a barcode of the trailer, the user driver's license, a bill of lading, and/or freight 22 transported (or to-be-transported) by the vehicle 20.

The user device 24 may receive the information for the check-in identifier in a number of ways. For example, the user may open an application on the user device 24 and enter a user name and password using the user interface 100. The user device 24 has stored thereon or retrieves from the remote server computer 50 profile information for the user such as driver's license number, trucking company, and insurance information as some examples. When the vehicle 20 picks up a trailer at a first location to deliver to the facility 10, the user device 24 receives a digital bill of lading and/or packing slip from the first location which includes freight information (e.g., SKUs, lot numbers, pallet numbers). The user utilizes the optical device 116 of the user device 24 to take a picture of a trailer number, barcode, or other machine-readable indicium of the trailer. The picture evidences that the user is actually picking up the trailer. The user device 24 communicates the received information to the remote server computer 50, such as once the vehicle 20 leaves the remote facility, during transit to the facility 10, and/or upon arrival at the facility 10. The user device 24 may also provide information to the remote server computer 50 during travel, such as location data, which permits real-time tracking of the vehicle 20.

In some embodiments, the freight information received by the user device 24 may be directly communicated to the remote server computer 50. Alternatively or additionally, the freight information may be recorded using a digital distributed ledger system, e.g., private blockchain. The remote server computer 50 and/or distributed ledger may maintain a detailed record of each shipped product as the product travels from facility to facility and eventually to a point of sale (as an example). The detailed record facilitates accurate supply chain tracking and traceability, such as for product recalls.

As discussed, the check-in communication 130 may be transmitted to remote server computer 50 via the network 52. Upon receiving the check-in communication 130, the remote server computer 50 performs an authorization check based at least in part on the check-in identifier. For example, the remote server computer 50 may determine whether the vehicle 20 is authorized to access the facility 10. The determination may include determining whether the user, vehicle 20, and/or user device 24 are authorized to access the facility 10; for example, within a particular date range, on a particular day, within a particular time range, and/or at a particular time.

In one example, the check-in communication 130 includes a vehicle identifier, and the memory includes a schedule indicating a particular time that the vehicle 20 is authorized to arrive at the facility 10. In this example, the remote server computer 50 may determine whether the vehicle 20 is authorized to access the facility 10 at the time of the check-in communication 130. If the vehicle 20 is not authorized to access the facility 10 at the time of the check-in communication 130, the remote server computer 50 may communicate with the user device 24 to inform the vehicle occupant that the vehicle 20 is not authorized to access the facility 10 at that time. The communication with the user device 24 may further inform the vehicle occupant of the time (or range of times) that the vehicle 20 is authorized to access the facility 10.

If the vehicle 20 is not authorized to access the facility 10, such as if there are no open loading docks, the remote server computer 50 may communicate an instruction to the user via the user device 24 to park the trailer of the vehicle 20 outside of the facility. This may occur, for example, if the user is delivering a trailer to the facility 10 outside of normal business hours.

At the time of the check-in communication 130, the remote server computer 50 may perform a presence verification process. For example, the remote server computer 50 may communicate with one or more sensors 60 at the facility 10 to verify the vehicle 20 has arrived at the facility 10.

In one embodiment, the remote server computer 50 may communicate with the movable barrier operator 40 for verification of vehicle presence at the movable barrier 32. The movable barrier operator 40 may be informed of a presence of the vehicle 20 at the movable barrier 32 through various approaches. In one approach, the movable barrier operator 40 communicates with one or more sensors 60 located at the movable barrier 32 of the facility 10. As such, the sensors 60 may report the detected presence of the vehicle 20 to the movable barrier operator 40.

In one example, verification of the presence of the vehicle 20 may include detecting a break in an optical beam transmitted by a photo beam system 62 that is in communication with the movable barrier operator 40, as indicated by signal 132. In another example, verification of the presence of the vehicle 20 may include detecting a change in the base frequency of an electrical signal transmitted by a loop detector 64 that is in communication with the movable barrier operator 40, as indicated at signal 134. The one or more sensors 60 may include other sensors 66 that are in communication with the movable barrier operator 40, as indicated at signal 136, may be used for detecting the presence of the vehicle 20 at the movable barrier 32. As discussed, such sensors 66 may include one or more of a passive infrared detector, a radio frequency receiver, a short-range (e.g., Bluetooth) receiver, a magnetic detector, a capacitance detector, a time-of-flight sensor, sound detector, and an optical detector (e.g., a camera).

In another approach, the movable barrier operator 40 is configured to directly detect a presence of a vehicle 20. For example, the communication circuitry 74 of the movable barrier operator 40 may communicate with the user device 24, as indicated at signal 138. Such communication may be, for example, via a short-range (e.g., Bluetooth) protocol.

The sensors 60 inform the movable barrier operator 40 of a presence or absence of a vehicle 20 at the perimeter barrier 12. The movable barrier operator 40 is configured to transmit a verification communication 140 to the remote server computer 50. The verification communication 140 may include, for example, information identifying the movable barrier operator 40 such as device ID, gate ID, and/or location (e.g., street name, latitude and longitude). The verification communication 140 may also include information detected by the sensors 60, such as an identification number or barcode of the trailer and/or tractor.

In still another embodiment, one or more of the sensors 60 may communicate a verification communication to the remote server computer 50 (e.g., via the network 52). For example, as shown in FIG. 1, a sensor 66 may communicate a verification communication 140′ to the remote server computer 50. Additionally or alternatively, one or both of the photo beam system 62 and the loop detector 64 may communicate a verification communication to the remote server computer 50. In this manner, one or more of the sensors 60 may include a long-range wireless communication interface and/or a wired communication interface.

In one approach, the one or more sensors 60 may continuously or periodically monitor for the presence of a vehicle 20. In another approach, the one or more sensors 60 may enter a “sleep” mode, and may check for the presence of a vehicle 20 in response to a “wake” signal transmitted from the movable barrier operator 40, the remote server computer 50, and/or the user device 24. For example, the movable barrier operator 40 may be configured to transmit a wake signal to the sensor 60 in response to the movable barrier operator 40 receiving a vehicle presence query from the remote server computer 50.

The various approaches described herein allow for the remote server computer 50 to be informed of a presence or absence of a vehicle 20 at the movable barrier 32 of a facility 10. For example, the remote server computer 50 may receive an affirmative indication (e.g., via verification communication 140, 140′) of a presence of the vehicle 20, or an affirmative indication of the absence of the vehicle 20 (e.g., as reported by a sensor 60 that does not detect the vehicle 20). Additionally or alternatively, the remote server computer 50 may infer an absence of the vehicle 20 in response to not receiving a verification communication 140, 140′.

Upon the remote server computer 50 determining the check-in identifier of the check-in communication 130 indicates authorization of the vehicle 20 to access the facility 10, and after receiving the verification communication 140, 140′, the remote server computer 50 is configured to cause the movable barrier operator 40 to move the movable barrier 32 between the closed position (shown in FIG. 1) to an open position whereby the vehicle 20 may pass into the secured premises 16. The remote server computer 50 may cause the movable barrier operator 40 to move the movable barrier 32 by communicating a control command to the movable barrier operator 40. The “entrance time,” which corresponds to the movable barrier operator 40 moving the movable barrier 32 between closed and open positions, may be stored in a memory at one or both of the movable barrier operator 40 (memory 72) and the remote server computer 50 (memory 92). The entrance time may be utilized as an electronic signature to check in (entry) and check out (exit) a vehicle 20 from a geographic location, facility gate, and/or dock.

Further, the entrance time recorded at the memory 72, 92 provides an independently obtained time the vehicle 20 entered the facility 10 which improves the accuracy of tracking movement of the vehicle 20. The remote server computer 50 may communicate a notification to a manager or management computer system of the facility 10 that indicates the vehicle 20 has entered at the movable barrier 32. The manager or management computer system may quickly assign staff to prepare to unload and/or load the vehicle 20.

The check-in process and the presence verification process, including operations thereof, may be performed in any suitable order. As such, the remote server computer 50 may cause the movable barrier operator 40 to move the movable barrier 32 in response to receiving the verification communication 140, 140′ after having previously received the check-in communication 130. In another example, the remote server computer 50 may cause the movable barrier operator 40 to move the movable barrier 32 in response to receiving the check-in communication 130 after having previously received the verification communication 140, 140′. In the latter approach, the remote server computer 50 may continuously or periodically receive a verification communication 140, 140′ such that the remote server computer 50 is aware of the presence of the vehicle 20 at the movable barrier 32 prior to receiving the check-in communication 130 from the user device 24.

The remote server computer 50 may receive confirmation of passage of the vehicle 20 through the opened movable barrier 32. For example, photo beam system 62, which previously had an interrupted photo beam while the vehicle 20 was positioned outside of the movable barrier 32, may report a series of interruptions as the wheels of the vehicle 20 travel through the photo beam. In another example, a forward photo beam system 62′, which previously had an uninterrupted photo beam while the vehicle 20 was positioned outside of the perimeter barrier 12, may report an interrupted photo beam. As another example, the sensor 60 may include a camera having image recognition operability to detect the vehicle 20 entering the facility 10.

Prior to, after, or concurrent with the opening of the movable barrier 32, the remote server computer 50 may communicate a loading dock identification to the user device 24 (e.g., to the communication circuitry 102 of the user device 24). The loading dock identification may include an instruction identifying a particular loading dock from among the plurality of loading docks 14. For example, the loading dock identifier may instruct the vehicle occupant to direct the vehicle 20 to “Dock 3” of the facility 10, as indicated at arrow 150. Alternatively or additionally, the loading dock identification may include navigation information, such as turn-by-turn directions or a map, for the user device 24 to present to the user.

In one embodiment, a particular loading dock may be selected based at least in part on dock availability. For example, “Dock 3” may be the only available loading dock or is the only loading dock with necessary space availability. Alternatively or additionally, a particular loading dock may be selected based at least in availability of at least one of staff and equipment (e.g., hazardous or cold storage).

In another embodiment, a particular loading dock may be selected based at least in part on freight to be delivered by the vehicle 20 or picked up by the vehicle 20. For example, “Dock 3” is the only loading dock equipped to handle hazardous material, or has the capability for storing the freight in the necessary storage environment (temperature, humidity, etc.). In another aspect, a particular loading dock may be selected based at least in part on dock personnel at the facility 10, e.g., dock workers are available at “Dock 3” but not at “Dock 1”. In another aspect, a particular loading dock may be selected based at least in part on loading dock accessories, e.g., a dock leveler is provided at “Dock 3” but not at “Dock 2”. In another aspect, a particular loading dock may be selected based at least in part on usage patterns of the plurality of loading docks. For example, the dock door operator associated with “Dock 3” may have a fewer number of operation events, e.g., “open” or “close,” than the dock door operator associated with “Dock 4.” In another aspect, a particular loading dock may be selected based at least in part on a maintenance schedule of the plurality of loading docks. For example, “Dock 1” may be scheduled for maintenance while the vehicle 20 is expected to be at the facility 10, so use “Dock 3” instead. Information used to assign a particular loading dock may be determined, for example, from a bill of lading or vehicle information (e.g., trailer number) that was communicated during the check-in process.

If no loading dock is available, but the vehicle 20 is permitted to enter the facility 10, the remote server computer 50 may transmit an instruction to the user device 24 instructing the user to drive the vehicle 20 to a waiting area 160.

The above-described instructions may be generated based on current status information associated with the facility 10. That is, the above-described instruction is based on a snapshot in time when the vehicle 20 arrives or is moved about the facility 10. As new events happen (e.g., new vehicles 20 arrive, existing vehicles 20 leave, etc.), the instructions for next actions may be generated to take advantage of resulting availabilities. For example, when a vehicle 20 leaves “Dock 2”, the remote server computer 50 can recognize that “Dock 2” has become available and assign the next-waiting vehicle 20 to “Dock 2”. This may be referred to as first-in-first-out (FIFO). Under a purely FIFO system, the facility 10 is managed using a simple function (algorithm) that does not account for updates, delays, changes, or the like. Moreover, a purely FIFO system may fail to deliver efficient use of the facility 10. For example, the facility 10 may have certain docks that are unused over extended periods of time as a result of an unexpected event (e.g., a delay of a vehicle to arrive at the facility 10).

Referring now to FIG. 5, in one or more implementations, the remote server computer 50 (or another computing device, or system of computing devices, having a processor coupled to memory storing computer-executable instructions) can utilize a rules optimizer 500 to schedule, or assist in scheduling, at least some of the operations at the facility 10. The rules optimizer 500 can formulate scheduling decisions for optimal use of the facility 10 without relying on FIFO alone to determine instructions for directing vehicles 20 within the facility 10. Instead, the rules optimizer 500 can determine scheduling decisions based on historical data, current data, future scheduled events, or a combination thereof in order to best generate scheduling decisions and subsequent instructions to direct vehicles 20 within the facility 10 to ideal locations (e.g., ideal loading docks). In one implementation, the rules optimizer 500 can operate independent of a rules generator 501 (e.g., a FIFO system). In another implementation, the rules optimizer 500 can operate together with the rules generator 501 (e.g., the FIFO system). The rules optimizer 500 can rely on optimization logic, such as an optimization algorithm, executed by the rules optimizer 500 to generate scheduling decisions. These scheduling decisions can be implemented, e.g., periodically, to inform scheduling decisions at the rules generator 501. For instance, the rules generator 501 may be configured to generate a schedule at the facility 10. The generated schedule can be formed in view of operations that are to be conducted at the facility 10 during the scheduled period of time. The rules generator 501 can assign operations at the facility 10 based on the generated schedule. The rules optimizer 500 can interact with the rules generator 501 to modify the generated schedule. The rules generator 501 can then adjust the generated schedule in response to the modifications received from the rules optimizer 500.

The scheduling decisions can be further optimized based on facility- or operator-specific preference(s). For instance, some facilities 10 may prioritize costs and fees associated with loading and unloading vehicles 20 while other facilities 10 may prioritize time to load and unload vehicles 20. These two example categories of prioritization may or may not have competing interests. For example, the least costly option may not be the quickest. Conversely, the quickest option may not be the cheapest. By selecting between different prioritizations, the rules optimizer 500 can provide optimized scheduling decisions which can inform instructions to direct vehicles 20 within the facility 10 based on the facility needs and priorities.

The rules optimizer 500 can include a prioritizer 508 which is selectable between two or more prioritizing schemes. The prioritizer 508 can be implemented as a user adjustable interface which allows the user to adjust between the two or more prioritizing schemes. By way of example, the user adjustable interface can include a display or screen that displays icons that the user can adjust. The display or screen may be a touch screen that the user touches to move the icons. The icons may include slider bars, rollable wheels, or the like. By adjusting the position of the icons, the user can adjust the relative weighting or prioritization set by the prioritizer 508. In another embodiment, the prioritizer 508 can include physical buttons and/or dials. For example, the prioritizer 508 can include a mixing board. The user can input changes to the physical buttons and/or dials to assign different relative weights or prioritization between the two or more prioritizing schemes. In yet another embodiment, the prioritizer 508 can be adjusted through voice controls. For example, the user can speak into a microphone to adjust the relative weights or prioritizations between the two or more prioritizing schemes. The remote server computer 50 can receive the spoken data input at the microphone and affect adjustment based thereupon. In an embodiment, the remote server computer 50 can implement a machine learning model to affect the adjustment. For example, when the user says “increase scheme A”, the remote server computer 50 can rely on the machine learning model to determine an appropriate initial relative adjustment to scheme A. Similarly, the remote server computer 50 can adjust other schemes to allow for the increase to scheme A using the machine learning model. In some instances, the user can receive feedback from the remote server computer 50, or another computing system associated with, or in communication with, the remote server computer 50, through a speaker. The speaker can provide the user with clarifying questions or guidance as generated by the remote server computer 50 and/or other computing system. For example, in response to receiving the instruction “increase scheme A”, the speaker can generate a speech output asking the user, for example, “how much should scheme A be increased?” or “would you like to decrease scheme B or scheme C to allow for the increased relative weighting of scheme A?”.

As described above, the two or more prioritizing schemes can include cost prioritization and time prioritization. The two or more prioritizing schemes can also include a “make special” prioritization, such as for example, personnel prioritization, shipping carrier prioritization, driver prioritization, or the like. Yet other types of prioritization can be implemented. These prioritization schemes can be binary (off or on) or adjustable, whereby relative weights can be assigned to each of the priorities (e.g., 60% prioritization to cost and 40% prioritization to time). By selecting a prioritizing scheme, the prioritizer 508 allows for custom workflow at the facility 10 in view of particular needs associated with that facility 10. These priorities can be adjusted on an as-needed basis or can remain in their current scheme over extended periods of time. The user may be able to adjust the refresh rate (i.e., how often the prioritization changes). For example, using the prioritizer 508, the user can set a retraining frequency, as described in greater detail below.

The prioritizer 508 may be accessible at the remote server computer 50, via the user device 24, at an on-site controller location, or a combination thereof. Upon receiving a desired prioritization, or in response to a default prioritization scheme, the rules optimizer 500 can define scheduling decisions to incur optimal use of the facility 10 and available resources. The scheduling decisions can generate instructions provided to relevant parties, such as drivers, facility personnel, and the like. The scheduling decisions and resulting instructions can direct the relevant parties to desired locations at desired times to perform operations, like loading or unloading a vehicle 20, at maximum efficiency to minimize wasted time and facility 10 resources.

Over time, the rules optimizer 500 can rely on ever greater amounts of historical data to inform future scheduling decisions. The historical data can be saved locally at the rules optimizer 500 (at a local memory 502), at a remote memory device, or both. The historical data can include information associated with previous events at the facility 10, such as previous loading and/or unloading times, delays, efficiency data and efficiency scores, information associated with different personnel groupings, individual worker efficiency, personnel schedules, or the like. The historical data can be segmented into groupings, such as by relevant party (e.g., by shipping carrier, individual driver, etc.), date or date range (e.g., daily, weekly, quarterly, etc.), environmental condition (e.g., sunny, rainy, windy, etc.), day of the week (e.g., Monday, Tuesday, Wednesday, etc.), or the like. Segmenting the historical data may allow for easier oversight of the rules optimizer 500, thereby allowing better customization and control. Additionally, or alternatively, segmenting historical data may allow for more accurate scheduling decisions by eliminating noise from the historical data.

The historical data can be analyzed by a processor 504 of the rules optimizer 500. The processor 504 can be any suitable processing device (e.g., a control circuitry, a processor core, a microprocessor, an application specific integrated circuit, a field programmable gate array, a controller, a microcontroller, etc.) and can be one processor or a plurality of processors that are operatively connected. The memory (e.g., memory 502) can include one or more non-transitory computer-readable storage media, such as RAM, ROM, EEPROM, EPROM, one or more memory devices, flash memory devices, etc., and combinations thereof. The memory 502 can store information that can be accessed by the processor(s) 504. For instance, the memory 502 (e.g., one or more non-transitory computer-readable storage mediums, memory devices) can include computer-readable instructions 506 that can be executed by the processor(s) 504. The instructions 506 can be software, firmware, or both written in any suitable programming language or can be implemented in firmware or hardware. Additionally, or alternatively, the instructions 506 can be executed in logically and/or virtually separate threads on processor(s) 504. For example, the memory 502 can store instructions 506 that when executed by the processor(s) 504 cause the processor(s) 504 to perform operations such as any of the operations and functions as described herein.

The rules optimizer 500 can rely on current data to inform scheduling decisions. Current data may include information associated with the facility 10 at, or near, the time the scheduling decision is made. Example current data include current vehicle location(s) (e.g., how far is the vehicle from the facility 10, etc.), traffic data (how congested are the roads near the facility 10 and/or how congested are the roads between the vehicle and the facility, etc.), estimated time to complete current operation(s) in progress, personnel status, equipment status, facility availability, current environmental conditions, and the like. Current data may be collected from sensors located at the facility 10 (e.g., inside the perimeter of the facility 10) or outside the facility 10. In some instances, the sensors may be controlled by the facility. For example, a presence detector at the perimeter of the facility 10 may be controlled by the facility owner. Data from the presence detector can be received at the rules optimizer 500 to allow for updated scheduling decisions. In other instances, the sensors may be controlled by an external entity (e.g., traffic information generated by a traffic sensor disposed on a light pole outside the facility and operated by the municipality). The information from the externally controlled sensors may be received at the rules optimizer 500 to allow for updated scheduling decisions.

The rules optimizer 500 can be configured to receive data from additional sensors after installation. For example, the rules optimizer 500 can be initially configured to receive data from only sensors located at the facility 10. This data can be received at the rules optimizer 500 and used to generate scheduling decisions. As the facility 10 grows and/or the nearby area incorporates new sensors that generate additional data, the rules optimizer 500 can be linked to the new sensors (directly through a wired or wireless connection, or indirectly through a third-party service). The rules optimizer 500 can receive the data from the new sensors and utilize the new data to inform scheduling decisions. In some implementations, new data (i.e., data that was not previously available such as data from a newly implemented sensor) can be assigned (e.g., automatically) a lower relative weighting as compared to already-received sensor data. That is, new data can incur a lower relative weighting as the sensor data is not yet fully understood by the rules optimizer 500. Once the volume of new data reaches a threshold criterion whereupon sufficient historical data exists to utilize the new data for scheduling decisions, the rules optimizer 500 can adjust the relative weighting of the new data. In some instances, the rules optimizer 500 can affect the threshold criterion in view of a machine learning model. For example, the rules optimizer 500 can compare and analyze the received data in view of a machine learning model trained to provide weighting to newly acquired sensor data. In some instances, the threshold criterion can be increased or decreased based on the received information from the machine learning model. In other implementations, the rules optimizer 500 can determine the threshold criterion based on a standard deviation of received data. Where the standard deviation is low (i.e., the data is consistent), the rules optimizer 500 can more quickly implement use of the newly acquired sensor data. Conversely, where the standard deviation is high (i.e., the data is variable or widely inconsistent), the rules optimizer 500 can implement a slower integration of the newly acquired sensor data. In this regard, the newly acquired sensor data is allowed to calibrate and baselines are established prior to implementing, or fully implementing, the newly acquired sensor data.

In some implementations, the rules optimizer 500 may be in communication with a server providing environmental conditions at or near the facility 10. Environmental conditions can include, for example, humidity, precipitation, temperature, air pressure, wind speed, or the like. One or more of the environmental conditions can be used by the rules optimizer 500, e.g., in view of historical data, to further inform scheduling decisions. For example, wet weather often incurs delays in vehicle arrival. These delays may be predicted by the rules optimizer 500 (e.g., in view of historical data) and the prediction used by the rules optimizer 500 to inform scheduling decisions.

In some implementations, the rules optimizer 500 may be in communication with a server providing traffic data. The traffic data can include local traffic data near the facility (e.g., at roads outside the facility), traffic data associated with individual routes of arriving vehicles, global or regional traffic data, or the like. Traffic data can be used by the rules optimizer 500 to estimate time of arrival and expected delays associated with arriving vehicles.

The rules optimizer 500 can further rely on future scheduled events to inform scheduling decisions. Future scheduled events include upcoming events that are expected to occur at the facility 10. Example future scheduled events include expected arrivals, expected departures, expected freight types, expected delays in view of personnel issues, planned dock maintenance, and the like.

The rules optimizer 500 can train one or more machine learning computing systems to input the historical data, the current data, the future scheduled events, or a combination thereof and output a scheduling decision. The machine learning computing system can include one or more computing devices. The machine learning computing system can include one or more processors and a memory. The one or more processors can be any suitable processing device (e.g., a processor core, a microprocessor, an ASIC, a FPGA, a controller, a microcontroller, etc.) and can be one processor or a plurality of processors that are operatively connected. The memory can include one or more non-transitory computer-readable storage media, such as RAM, ROM, EEPROM, EPROM, one or more memory devices, flash memory devices, etc., and combinations thereof. The memory can store information that can be accessed by the one or more processors. For instance, the memory (e.g., one or more non-transitory computer-readable storage mediums, memory devices) can store data that can be obtained, received, accessed, written, manipulated, created, or stored. The data can include, for instance, sensor data, two-dimensional data, three-dimensional, image data, LiDAR data, object model parameters, simulation data, data associated with models, or any other data or information described herein. In some implementations, the machine learning computing system can obtain data from one or more memory device(s) that are remote from the machine learning computing system.

The memory can also store computer-readable instructions that can be executed by the one or more processors. The instructions can be software written in any suitable programming language or can be implemented in hardware. Additionally, or alternatively, the instructions can be executed in logically or virtually separate threads on processor(s). For example, the memory can store instructions that when executed by the one or more processors cause the one or more processors (the computing system) to perform any of the operations or functions described herein, including, for example, training a machine-learned object parameter estimation model, generating simulation data, etc.

In some implementations, the machine learning computing system includes one or more server computing devices. If the machine learning computing system includes multiple server computing devices, such server computing devices can operate according to various computing architectures, including, for example, sequential computing architectures, parallel computing architectures, or some combination thereof.

In addition, or alternatively to the model(s) at the computing system, the machine learning computing system can include one or more machine-learned models. As examples, the machine-learned models can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

In some implementations, the machine learning computing system can train the machine-learned models through use of a model trainer. The model trainer can train the machine-learned models using one or more training or learning algorithms. One example training technique is backwards propagation of errors. In some implementations, the model trainer can perform supervised training techniques using a set of labeled training data. In other implementations, the model trainer can perform unsupervised training techniques using a set of unlabeled training data. By way of example, the model trainer can train the machine-learned object parameter estimation model through unsupervised energy minimization training techniques using the objective function described herein. The model trainer can perform a number of generalization techniques to improve the generalization capability of the models being trained. Generalization techniques include weight decays, dropouts, or other techniques.

The machine learning computing system can include a communication interface. The communication interface can be used to communicate with one or more systems or devices, including systems or devices that are remotely located from the machine learning computing system. A communication interface can include any circuits, components, software, etc. for communicating with one or more networks. In some implementations, a communication interface can include, for example, one or more of a communications controller, receiver, transceiver, transmitter, port, conductors, software or hardware for communicating data. The network(s) can be any type of network or combination of networks that allows for communication between devices. In some embodiments, the network(s) can include one or more of a local area network, wide area network, the Internet, secure network, cellular network, mesh network, peer-to-peer communication link or some combination thereof and can include any number of wired or wireless links. Communication over the network(s) can be accomplished, for instance, through a network interface using any type of protocol, protection scheme, encoding, format, packaging, etc.

The rules optimizer 500 may adapt, learn, or otherwise adjust the one or more machine learning models in view of current data or future scheduled events not previously available or known to the rules optimizer 500 (i.e., not-yet-historical data). This may be referred to as retraining.

The rules optimizer 500 may use newly acquired current data, which thereafter becomes historical data, to retrain the rules optimizer 500 in order to provide optimal performance that improves over time. For example, if a particular shipping carrier, facility, driver, etc. shows historical tendencies (e.g., tardiness, longer-than-expected load or unload times, etc.) over a period of times or successive operations, the rules optimizer 500 can account for the historical tendencies when making future scheduling decisions. For example, if shipping carrier X averages 15-minute delays for their vehicles to arrive at the facility, the rules optimizer 500 can update a current schedule to account for this delay, for example, by shuffling the vehicles to better maintain optimal dock loading capacity near 100%. Alternatively, if certain shipping routes typically incur delays, the rules optimizer 500 can update a current schedule to account for expected delays.

In some implementations, retraining can occur periodically, e.g., at set intervals such as every ten minutes, every hour, every day, every week, or the like. In other implementations, retraining can occur on an ongoing basis. For example, the rules optimizer 500 can retrain every time a new historical data is saved. In yet other implementations, retaining can occur upon the new historical data exceeding a prescribed threshold. For example, when new historical data is repeatedly obtained over a sufficient duration of time or after a sufficient number of occurrences, such that a pattern emerges, the rules optimizer 500 can account for the historical data and reflect changes in the future scheduling decisions.

Upon determining that the rules optimizer 500 needs to be retrained, the rules optimizer 500 can follow the same or similar steps as those taken with regard to initially training the rules optimizer 500. The rules optimizer 500 may collect the historical data, or a portion thereof, and analyze aspects of the historical data. Analyzing can include, for example, determining aspects associated with time, cost, or the like. The rules optimizer 500 can further determine whether sufficient historical data exists to warrant retraining. For example, where a series of scheduled events took longer than expected, but amount to less than prescribed threshold of scheduled events (e.g., less than 2% of total scheduled events), the rules optimizer 500 may exit the retaining. That is, the rules optimizer 500 may only enter retraining when sufficient historical data exists to warrant the retraining. The rules optimizer 500 can then await additional information (e.g., additional historical data) that accumulates until the prescribed threshold is achieved. Where the series of scheduled events amount to greater than the prescribed threshold of scheduled events (e.g., greater than 2% of total scheduled events), the rules optimizer 500 can continue with the retraining.

In some instances, the rules optimizer 500 can determine that one or more events no longer warrants consideration for purposes of retraining. For example, where a particular shipping company exhibits repeated delays over successive visits to the facility but later shows on-time arrivals over a sufficient number of arrivals, the rules optimizer 500 can reduce the impact of the earlier delays on any future retraining. In some instances, the rules optimizer 500 may even purge the historical data associated with the older delays where it is determined those delays are no longer relevant for future rule optimization. For example, where a particular shipping company exhibited a five (5) visit span of delays but has since performed twenty-five (25) on-time visits, the rules optimizer 500 may purge the historical data associated with the five (5) visit span. In this regard, the rules optimizer 500 is not affected by inaccurate (out-of-date) historical data. Alternatively, or in addition, the rules optimizer 500 can provide a weighted average to the historical data. Each historical data point can receive a weighting, e.g., based upon its occurrence in time. Older historical data can be weighed less heavily than more recent historical data. Each historical data can then impact the rules optimizer 500 in view of its prescribed weighting.

By way of example, a particular shipment which once took 2 hours to unload over the course of ten (10) visits to the facility 10 may now take 1.5 hours to unload over the most recent ten (10) visits. The rules optimizer 500 can assign the original 2-hour unload times with a first weighted average (e.g., 0.5) and assign the new 1.5-hour unload times with a second weighted average (e.g., 0.9), resulting in an average unload time (for purpose of determining retraining) closer to the first weighted average (e.g., 1.55 hours). Thus, the new historical data is more heavily relied upon than older historical data. In this regard, the rules optimizer 500 may account for deviations without constantly retraining and creating inefficiencies incurred by workers at the facility. That is, facility workers are not constantly changing routines in view of slight variance and issues which may not have been relevant for future scheduling decisions.

By way of another example, the rules optimizer 500 can rely on mean, median, or mode when assigning weighted averages to historical data. For example, where the mean unloading time is 2 hours but the mode is 1.75 hours, the rules optimizer 500 may more heavily weigh 1.75 hours as the expected unloading time. Where modal information is distributed between two or more values (i.e., the historical data is multimodal), the rules optimizer 500 can assign the same or different elevated weighted averages to each of the mode values. The mean or median value(s) may also, or alternatively, be more heavily weighted than other values contained in the historical data.

Yet further, the rules optimizer 500 may be configured to discard historical data outside of a set parameter. For example, historical data outside of an acceptable standard deviation (e.g., two, three, or four standard deviations from the mean) can be discarded from the data set. The acceptable standard deviation can be selected by the facility overseer or automatically monitored and adjusted for by the rules optimizer 500. Alternatively, or in addition, at least some of the historical data may be manually removable or modifiable, such as by a facility operator or facility overseer, to account for individual, unexpected events. For example, it is undesirable for a vehicle that incurs a flat tire at the loading dock to cause future scheduling decisions to be affected. Instead, the facility operator can manually remove historical data associated with the event (flat tire) from the data set to prevent undesirable inclusion in retraining of the rules optimizer 500. Alternatively, if the data inferred from the event it outside the acceptable deviation, the associated data may be discarded automatically by the rules optimizer 500.

Assignment of weighted averages can also be performed through self-learning. Automatic assignment of weighted averages may be programmed by a fixed valuation or through learned adjustment. For learned adjustment, the rules optimizer 500 can record improvements in the scheduling decisions and compare previous scheduling decision changes to current conditions. Where current conditions indicate that a previous scheduling decision change was unwarranted (e.g., the previous scheduling decision did not improve efficiency), the rules optimizer 500 can automatically adjust the weighting to arrive at a better efficiency. In this regard, the rules optimizer 500 may not only optimize schedule decisions but also optimize the occurrence of retraining.

In addition to generating scheduling decisions for vehicles 20 with respect to the facility 10, the rules optimizer 500 can further generate scheduling decisions for various aspects of the facility 10 itself. For example, the rules optimizer 500 can determine scheduling of personnel or equipment at the facility 10. Where certain personnel or equipment are repeatedly tardy to arrive at a scheduled operation (e.g., loading or unloading of a vehicle 20), the rules optimizer 500 can adjust the schedule of the personnel or equipment to ensure on-time arrival. By way of non-limiting example, where “Dock 1” and “Dock 5” are far apart from each other and “Dock 3” is between “Dock 1” and “Dock 5”, and where all personnel required for a scheduled operation are already at “Dock 1” but the vehicle 20 at “Dock 1” is not yet scheduled to leave, the rules optimizer 500 may elect to schedule a newly arrived vehicle 20 at “Dock 3” to reduce time required for personnel to arrive at the newly arrived vehicle 20. By way of another non-limiting example, where a facility 10 is divided into separate personnel groupings and different efficiencies are detected between the different groupings (e.g., one personnel grouping is 10% faster than the other personnel grouping), the rules optimizer 500 may optimize placement of the vehicle 20, the personnel groupings, or both to optimize travel time and reduce down time and waiting time prior to arriving at the vehicle 20. The rules optimizer 500 may also, or alternatively, adjust between personnel grouping assignments in view of real time data. For example, where a first personnel grouping is falling behind in their operating task but is scheduled to arrive at a neighboring loading dock to load another vehicle 20, the rules optimizer 500 can automatically reassign the neighboring loading dock task to a second (different) personnel grouping. The second personnel grouping may be selected in view of their expertise and experience, their proximity to the neighboring loading dock, their remaining time to complete a current operation, their available equipment, in view of their remaining scheduled work time, other similar attributes, or any combination thereof. The personnel groupings can thus be efficiently managed by the rules optimizer 500 to reduce latency and waiting time while maximizing efficiency.

In yet a further embodiment, where the rules optimizer 500 determines that a future specialized operation requires a particular (first) personnel grouping or equipment but that other (second) personnel grouping(s) can perform a current needed operation, the rules optimizer 500 can assign one of the other (second) personnel grouping(s) to the current needed operation and schedule the particular (first) personnel grouping to the future specialized operation. The particular (first) personnel grouping can be assigned to an interim operation before occurrence of the future specialized operation in view of an estimated time remaining before the future specialized operation. For example, where the future specialized operation is in 45 minutes, the particular (first) personnel grouping will be available in 10 minutes, and wherein an interim operation requires 30 minutes, the rules optimizer 500 can schedule the particular (first) personnel grouping to the interim operation requiring 30 minutes. An other (second) personnel grouping currently assigned to the interim operation requiring 30 minutes can be reassigned by the rules optimizer 500 from the interim operation to another operation. In this regard, the rules optimizer 500 can adjust workflow of facility personnel to maximize worker efficiency and reduce down time while also ideally assigning tasks to the most ideal personnel or personnel grouping.

Similarly, the rules optimizer 500 can monitor equipment usage and needs based on scheduled operations and assign vehicles 20 to particular loading docks already equipment the necessary equipment. In a FIFO system, a vehicle may be assigned to a less-than-ideal dock (as it pertains to available equipment) based on availability. Using the rules optimizer 500, the ideal dock is selected based on availability of the equipment. The rules optimizer 500 can track the equipment, e.g., by monitoring the equipment, by receiving information from personnel regarding the location of said equipment, or the like.

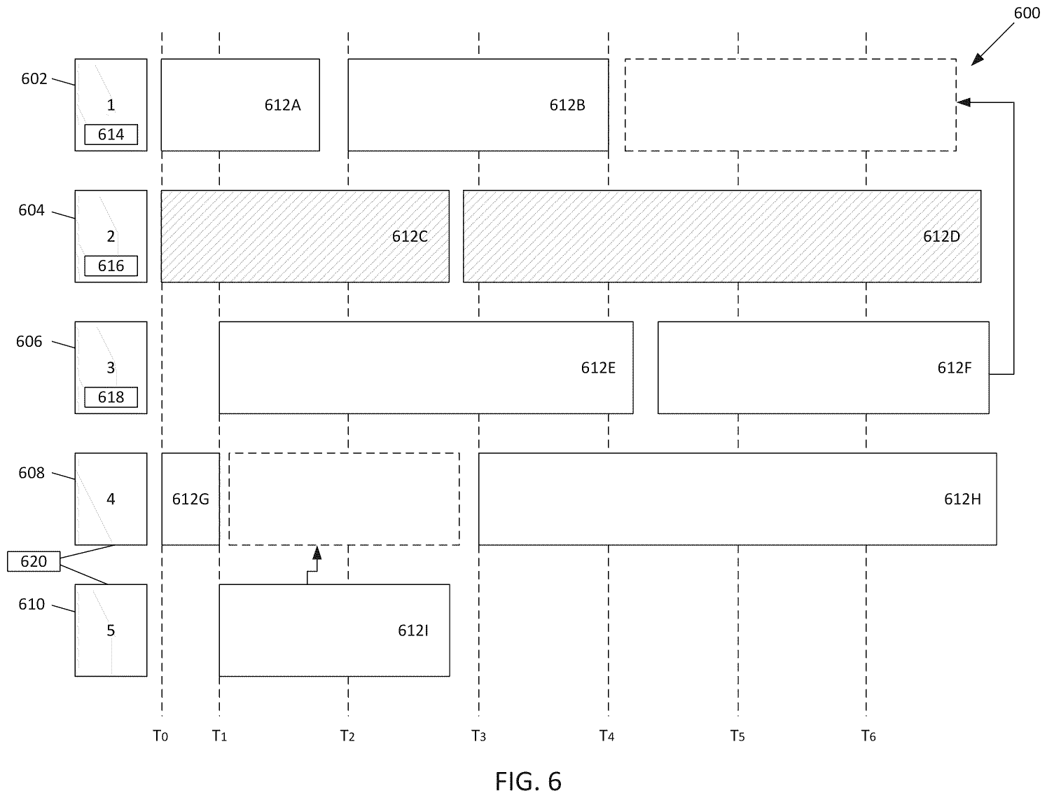

FIG. 6 illustrates an example schedule 600 of a facility (such as the facility 10) in accordance with an embodiment. The schedule 600 depicts five (5) loading docks, labeled as “Dock 1” 602, “Dock 2” 604, “Dock 3” 606, “Dock 4” 608, and “Dock 5” 610. It should be understood that the facility can include any number of loading docks, such as less than five docks or greater than five docks. The depicted schedule 600 is merely intended to be illustrative of an example schedule.

The schedule 600 is divided into times T₀, T₁, T₂, T₃, T₄, T₅, and T₆ with scheduled operations 612A, 612B, 612C, 612D, 612E, 612F, 612G, 612H, and 612I occurring before, between, and after times T₀ and T₆. Operations 612A and 612B are scheduled for “Dock 1” 602, operations 612C and 612D are scheduled for “Dock 2” 604, operations 612E and 612F are scheduled for “Dock 3” 606, operations 612G and 612H are scheduled for “Dock 4” 608, and operation 612I is scheduled for “Dock 5” 610. “Dock 2” 604 is a specialized dock with operations 612C and 612D including specialized operations associated with the specialized dock. An example specialized operation includes cold storage with access to a cold storage facility. Operations 612A, 612B, 612E, 612F, 612G, 612H, and 612I are non-specialized operations that can be performed at any one of “Dock 1” 602, “Dock 3” 606, “Dock 4” 608, or “Dock 5” 610. Each operation 612A, 612B, 612C, 612D, 612E, 612F, 612G, 612H, and 612I is associated with a different vehicle 20 (FIG. 1). When one operation is complete, the vehicle 20 associated with that operation leaves the corresponding dock and makes room for a new vehicle 20 to enter the same dock. Some nominal amount of time is required between successive operations to allow for the previous vehicle 20 to leave and the new vehicle 20 to arrive.

The following examples are intended to illustrate use of the rules optimizer 500 to optimize scheduling decisions associated with the schedule 600. In the example depicted in FIG. 6, a first personnel grouping 614 is working at “Dock 1” 602 between times T₀ and T₆, a second personnel grouping 616 is working at “Dock 2” 604 between times T₀ and T₆, a third personnel grouping 618 is working at “Dock 3” from time T₁ to T₆, a fourth personnel grouping 620 is working at “Dock 4” 608 and “Dock 5” 610 between time T₀ to T₆. The fourth personnel grouping 620 is scheduled to move from “Dock 4” 608 to “Dock 5” at time T₁ upon completion of operation 612G. If operation 612G finishes early (i.e., prior to time T₁), the rule optimizer 500 can adjust the schedule 600 to move the vehicle 20 associated with the operation 612I to “Dock 4” 608. In this regard, the fourth personnel grouping 620 is not required to relocate to “Dock 5” 610, but can instead remain at “Dock 4” 608 to perform operation 612I. This reduces personnel fatigue and allows for more efficient time management while simultaneously giving the fourth personnel grouping 620 a break between operations 612G and 612I. Additionally, “Dock 5” 610 can remain in a closed position and does not need to be made ready to receive a vehicle 20.

In some implementations, the rule optimizer 500 can further delay operation 612I in view of the additional time allotted between times T₁ and T₃. That is, operation 612I is scheduled to take less than the duration of time between times T₁ and T₃. The rule optimizer 500 can position operation 612I within the times T₁ and T₃ to prevent the operations from overlapping and to provide sufficient time for the vehicle 20 to leave “Dock 4” 608.

In an embodiment, the rule optimizer 500 can further assess the likelihood that operation 612H is on-time. If the vehicle 20 associated with operation 612H has historical data indicating a high probability of tardiness (late arrival), the rule optimizer 500 may provide an even larger gap of time between the completion of operation 612G and the beginning of operation 612I. If, on the other hand, the vehicle 20 associated with operation 612H arrives earlier than expected, the vehicle 20 associated with operation 612H can be instructed to move to “Dock 5” 610. In this regard, the schedule 600 is updated in real time based on historical data, current data, and future scheduled operations.

By way of another example, if operation 612E is running behind schedule (e.g., the freight is more difficult to load or unload than expected), the rule optimizer 500 can adjust the schedule 600 to accommodate the operation 612F without delay. For example, the rule optimizer 500 can move operation 612F to “Dock 1” 602. In some instances, the rule optimizer 500 can further reassign the third personnel grouping 618 to another location after completing operation 612E. That is, after moving the operation 612F away from “Dock 3” 606, the third personnel grouping 618 can be reassigned to a new operation at “Dock 3” 606 or be reassigned to a new dock.

As described above, the rule optimizer 500 can move and reassign the vehicles 20 between the docks based on available information associated with the current status of the docks and the vehicles 20. Moreover, the rule optimizer 500 can adjust future scheduling in view of expected future changes. For example, the fourth operation 612D is associated with a specialized operation, such as cold storage. Cold storage is typically used for articles that require cold temperatures during transportation. For example, certain produce may require refrigerated trailers. The refrigerated trailers may further include electrical hookups that can be plugged into power at “Dock 2” 604. Delays associated with these specialized operations (e.g., cold storage) can cause irrevocable damage to the entire freight if not properly addressed. Thus, any delay to operation 612C must be addressed to prevent spoilage of the freight associated with operation 612D. This may involve rerouting the vehicle associated with the specialized operation to a different facility or providing instructions to the vehicle to park at a waiting area where the vehicle can be connected to a local power source.

In one or more implementations, the rule optimizer 500 can communicate with the vehicle 20 transporting the specialized freight associated with operation 612D in the event that operation 612C is behind schedule. For example, the rule optimizer 500 can instruct the vehicle 20 transporting the specialized freight associated with operation 612D to visit a temporary electrical hookup to receive electrical power while waiting for “Dock 2” 604 to become available. The electrical hookup allows the vehicle to maintain the specialized freight under cold storage. The rule optimizer 500 can generate a message and communicate with the vehicle 200 to provide instructions to the nearest electrical hookup (at the facility 10 or offsite). The rule optimizer 500 can track current progress of the operation 612C and subsequently generate instructions for the vehicle 20 to arrive at “Dock 2” when the operation 612C is completed and “Dock 2” 604 becomes available. In some instances, the rules optimizer 500 can generate the instructions for the vehicle 20 prior to the operation 612C completing. For example, the rules generator 500 can determine the duration of time needed for the vehicle 20 to arrive at “Dock 2” 604. The rules generator 500 can further determine a remaining amount of time to complete operation 612C. When the remaining amount of time to complete operation 612C reaches a critical threshold with respect to the duration of time needed for the vehicle 20 to arrive at “Dock 2” 604 (e.g., when the time necessary for the vehicle 20 to reach “Dock 2” 604 is greater than the remaining amount of time to complete operation 612C) the rules optimizer 500 can generate an instruction for the vehicle 20 to move to “Dock 2” 604. In this regard, the rules optimizer 500 can minimize downtime of the vehicle and maximize usage of the facility 10 and the specialized “Dock 2” 604. These determinations can be made in view of the historical data in addition to the current data associated with the facility 10.

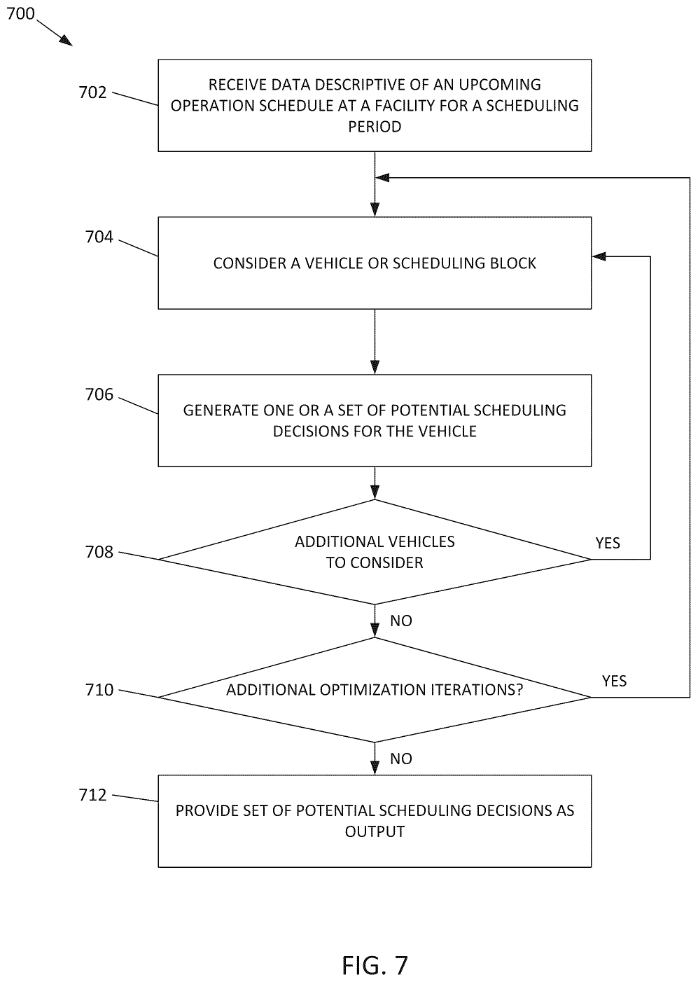

FIG. 7 depicts a flow chart diagram of an example method 700 of generating a scheduling decision for a facility (such as the facility 10) according to example embodiments of the present disclosure. One or more portion(s) of the method 700 can be implemented by a computing system that includes one or more computing devices such as, for example, the computing systems described with reference to the other figures (e.g., the remote server computer 50, the gateway device 250, the processor 504, etc.). Each respective portion of the method 700 can be performed by any (or any combination) of one or more computing devices. Moreover, one or more portion(s) of the method 700 can be implemented as an algorithm on the hardware components of the device(s) described herein (e.g., as in FIG. 5), for example, to generate scheduling decisions on a vehicle-by-vehicle basis. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 7 is described with reference to elements/terms described with respect to other systems and figures for exemplary illustrated purposes and is not meant to be limiting. One or more portions of the method 700 can be performed additionally, or alternatively, by other systems.

At step 702, the method 700 can include receiving data descriptive of an upcoming operation schedule at the facility for a scheduling period. The data can include, for example, information associated with the physical facility (e.g., dock availability, planned maintenance, road closures, etc.), information associated with onsite personnel or equipment (e.g., locations of personnel, location of equipment, personnel efficiency information, etc.), information associated with arriving vehicles (e.g., expected arrival times, etc.), information associated with expected delays (e.g., due to weather, traffic, etc.), historical data (e.g., historical patterns, etc.), current conditions, or the like. A computing system can receive the data descriptive of the upcoming operation schedule from local memory, a remote server, a user input, or the like. In some implementations, the data can include an initial schedule (e.g., as in FIG. 6) that provides initial scheduling decisions associated with the facility. The initial scheduling decisions can be manually entered, entered using a default algorithm (e.g., FIFO), or the like. The initial scheduling decisions can form a baseline for scheduling activity at the facility. In some instances, the initial schedule may be used without requiring any changes. That is, the initial schedule may be executed as-is. In other instances, the initial schedule may be changed (adjusted) (e.g., by the rules optimizer 500) in response to historical data, current data, or updates to future scheduling events.

At step 704, the method 700 can include considering a vehicle or scheduling block associated with the initial schedule. For example, the vehicle may correspond to a next vehicle expected to arrive at the facility. The vehicle may alternatively, or additionally, correspond to a vehicle for which a special consideration is required that has already arrived at the facility or which is expected to arrive at the facility. The special consideration may include a known status of the vehicle (e.g., delayed, cancelled, etc.). Once the special consideration is determined, the method can include considering that vehicle or other vehicles that may be affected by the special consideration. For scheduling blocks, the step 704 can include considering a particular period or duration of time associated with a particular location of the facility.

At step 706, the method 700 can include generating one or a set of potential scheduling decisions for the vehicle and/or scheduling block. For example, the computing system can generate a set of potential scheduling decisions for the currently considered vehicle or other vehicle(s) affected by the vehicle. The set of potential scheduling decisions can be determined in view of facility plans that optimize a facility objective function (e.g., in view of prioritizations, historical data, other future scheduled events, or the like).

For example, the computing system can generate a set of scheduling decisions for a particular vehicle by starting at the beginning of a current scheduling period and sequentially generating/adding vehicle plans for the vehicle until the end of the current scheduling period is reached. As one example, at each instance in which the computing system attempts to generate a new scheduling decision for a vehicle, the computing system can generate a plurality of candidate scheduling decisions, score each candidate scheduling decision (e.g., according to the facility objective function), and then select and add the highest scoring scheduling decision for the vehicle.

As described herein, the facility-level objective function can balance any number of different objectives, including, as examples, various objectives which are a function of need for the generated scheduling decision (e.g., whether the freight requires special operations or equipment, the size of the freight, the urgency of routing the freight, conditions at the facility, etc.). To evaluate such an objective function that includes objectives that are a function of need, the system can query a model to obtain forecasted information and/or availability information that can be used to evaluate such objectives. In another example, the facility-level objective function may focus (e.g., include as the sole objective) on maximizing the total number of operations carried out at the facility (e.g., to maximize facility efficiency).

In some implementations, the objective function can evaluate a set of scheduling decisions based, at least in part, on an ultimate journey for the vehicle and/or the vehicle freight. For example, an objective can include a function to reduce the total travel time (e.g., loading and unloading time) for the freight. By way of example, the need data can include an anticipated need (e.g., forecasted need data determined by a forecasting system) for freight services. At times, the freight services can include multi-modal freight services. The objective function can evaluate the set of scheduling decisions based, at least in part, on the total estimated time for the freight to be moved (e.g., loaded, unloaded, stored, and transported). For example, the computing system can identify infrastructural, traffic, weather, and/or other factors that can have an impact on a subsequent ground transportation leg and optimize the set of potential scheduling decisions to lower the total estimated travel time.

By way of example, the computing system can take ground-based transportation information (e.g., provided by world state, forecasting system(s), service provider computing device(s), infrastructure and operations computing device(s), etc.) into account when generating the set of scheduling decisions.

The computing system can evaluate the set of scheduling decisions based, at least in part, on how close the set of potential scheduling decisions can transport freight (e.g., expected based on forecasted need data, etc.) to an expected ultimate destination. For example, the forecasted need data can include an expected ultimate destination for each vehicle or freight. The computing system can generate the set of potential scheduling decisions in order to facilitate the transport of the vehicle or freight to a location (e.g., a transport node) closest to the expected ultimate destination. Where quick delivery is required for a particular freight, the computing system can prioritize that freight to a high-capacity dock area (e.g., having additional onsite personnel and/or enhanced equipment capable of quicker operational capacity).

In some implementations, the computing system can include a refueling component. The refueling component can assign a vehicle to participate in refueling and/or recharging whenever the vehicle is at the dock (e.g., for more than a minimum amount of time) and refueling/recharging infrastructure (e.g., as indicated by infrastructure and operations computing device(s), etc.) is available at the vehicle's current location. The refueling component can be applied after generation of the scheduling decision(s) or can be used as part of the generation process itself. In such fashion, the use of refueling/recharging infrastructure can be optimized. In some instances, refueling may be located on-site (e.g., at one or more of the docks or in a holding yard or other location on the facility site). In other instances, refueling may be accounted for, e.g., in response to estimated wait times. Where a vehicle is determined to require urgent refueling, the computing system may generate scheduling decisions that route the vehicle to the refueling/recharging infrastructure on site or even advance the vehicle to an earlier time slot (i.e., skipping other vehicles) to ensure the vehicle is able to get to refueling/charging infrastructure prior to exhausting the fuel/charge supply.

In some implementations, the computing system can perform or participate in an iterative learning process for weights of planning objective function(s). For example, an initial set of weights for the objective function(s) can be manually tuned. The computing system can operate with the initial set of weights to generate any number of scheduling decisions for any number of scheduling periods. Outcomes associated with the generated scheduling decisions can be observed and measured according to various metrics. The set of weights can be retuned (e.g., automatically and/or manually) based on the observed outcomes. For example, various learning techniques such as gradient descent techniques can be applied to learn the set of weights. For example, gradient descent techniques can be applied to the weights of facility-level objective function or the vehicle-level objective function. More generally, the computing system can collect any data that describes the outcomes of certain manually-controlled settings, actions, weightings, decisions, and/or the like and can apply machine learning techniques to such data to learn updated or optimized versions of such settings, actions, weightings, decisions, and/or the like.

In this manner, the computing system can automatically generate the set of potential scheduling decisions for a vehicle owned and/or operated by one or more different carriers. In some implementations, each scheduling decision can be approved by a respective vehicle operator (e.g., via service provider computing device(s)). For example, each vehicle operator can be associated with a preapproval rule set. The preapproval ruleset, for example, can outline one or more acceptable scheduling decisions (e.g., from/to/between one or more approved locations, within an approved time period, etc.) for vehicles under the operational control of the respective vehicle operator. In some implementations, the set of potential scheduling decisions can only include approved scheduling decisions. In addition, or alternatively, the set of potential scheduling decisions can include unapproved scheduling decisions. In such a case, the unapproved scheduling decisions can be provided (e.g., escalated) to the respective vehicle operator for manual approval. The computing system can modify and/or regenerate any scheduling decision that is not manually and/or preapproved by a respective vehicle operator.

At step 708, the method 700 can include determining whether additional vehicles or scheduling blocks should be considered, e.g., if one or more vehicles remain unaccounted for or are not yet at the facility. If additional vehicles remain, then method 700 can return to step 704 and consider the next vehicle. However, if it is determined, at step 708, that all vehicles in the upcoming schedule have been considered, then method 700 can proceed to step 710.

At step 710, the method 700 can include determining whether an additional optimization iteration should be performed. For example, the computing system can determine whether an additional optimization iteration should be performed. Any number of iterations can be performed to allow for the scheduling decisions generated for different vehicles to balance and move around each other. For example, the vehicle can be considered in a different sequence at each iteration. Iterations can be performed until one or more stopping criteria are met. Stopping criteria can include a loop counter meeting a threshold, iteration-over-iteration change in objective function score(s) falling below a threshold, raw objective function score(s) exceeding a threshold, and/or other criteria. However, in some instances, only a single iteration is performed.

If it is determined, at step 710, that an additional iteration should be performed, then method 700 can return to step 704 and perform another iteration of scheduling decision generation for some or all of the schedule or vehicle. However, if it is determined, at step 710, that an additional iteration should not be performed, then method 700 can proceed to step 712. At step 712, the method 700 can include providing the set of potential scheduling decisions as an output. For example, the computing system can provide the set of potential scheduling decisions as an output. The scheduling decisions can be selected between and the computing system can update a schedule associated with the facility in view of the selected scheduling decision. The selected scheduling decision can be communicated, for example, to a facility and/or vehicle to affect an action of the facility and/or vehicle. For example, the vehicle may be assigned to a different dock than originally intended. The vehicle can thus be caused to move through the facility differently. By way of another example, the vehicle may be assigned to a waiting area and drive to the waiting area in response to the selected scheduling decision. Alternatively, or additionally, the loading dock may be prepared differently through one or more automated, or semi-automated processes, in response to an updated scheduling decision. For example, where the original schedule called for arrival of a first type of trailer and the updated schedule calls for arrival of a second type of trailer, the loading dock may reconfigure in response to the updated schedule so as to permit accommodation of the second type of trailer.

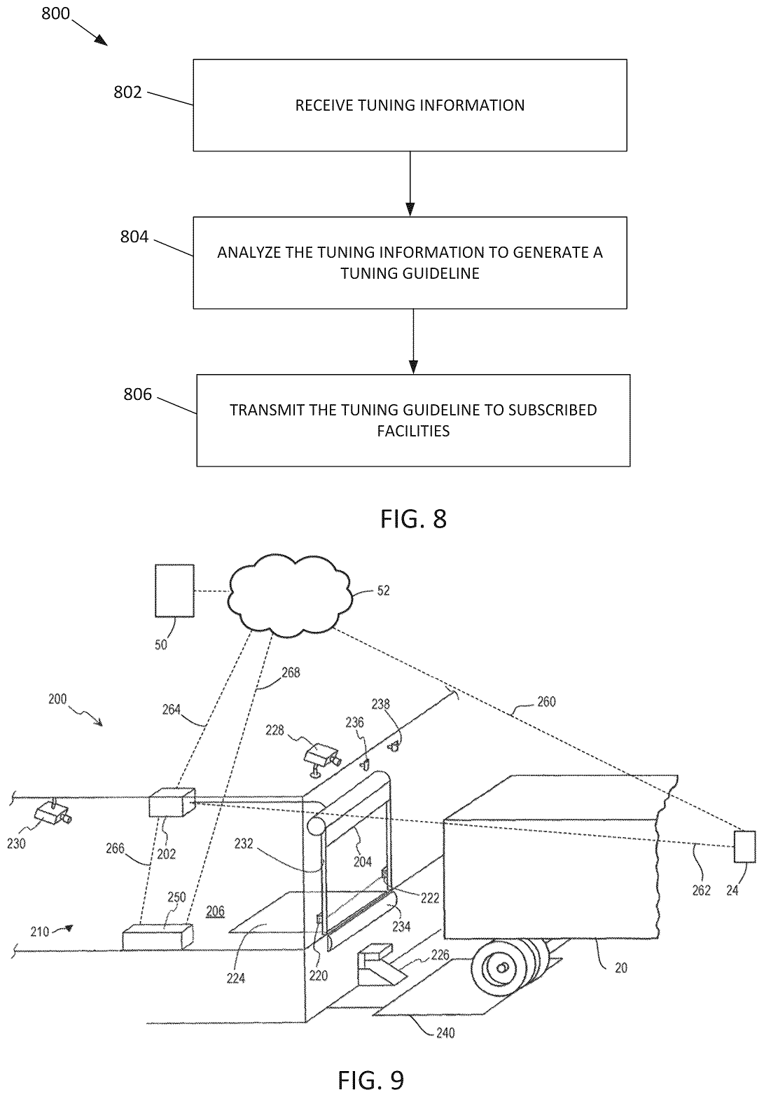

FIG. 8 depicts a flow chart diagram of an example method 800 of tuning a rule optimizer between different facilities according to example embodiments of the present disclosure. One or more portion(s) of the method 800 can be implemented by a computing system that includes one or more computing devices such as, for example, the computing systems described with reference to the other figures (e.g., the remote server computer 50, the gateway device 250, the processor 504, etc.). Each respective portion of the method 800 can be performed by any (or any combination) of one or more computing devices. Moreover, one or more portion(s) of the method 800 can be implemented as an algorithm on the hardware components of the device(s) described herein (e.g., as in FIG. 5), for example, to tune the rule optimizer. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 8 is described with reference to elements/terms described with respect to other systems and figures for exemplary illustrated purposes and is not meant to be limiting. One or more portions of the method 800 can be performed additionally, or alternatively, by other systems.

The method 800 can include a step 802 of receiving tuning information from one or more facilities. The tuning information may include scheduling decisions affected at one or more facilities in view of the rule optimizer (such as the rule optimizer 500) at that/those facility(ies) determining an updated scheduling decision. The tuning information can be received at a remote server computer (such as the remote server computer 50). The tuning information can include information associated with the updated scheduling decision, such as information used to formulate the updated scheduling decision, the calculation used to perform the updated scheduling decision in view of the information, the updated scheduling decision, etc. The method 800 can include a step 804 of analyzing the tuning information to generate a tuning guideline. The tuning guideline can include, for example, guidelines formed in view of the tuning information. The guidelines can include information which, if received at one or more other facilities (and more particularly the rules optimizer associated with the other facilities), could improve an operational functionality at the one or more other facilities. The guidelines may be specific to individual vehicles and situations or more generally related to global conditions. For example, where received tuning information indicates a vehicle is delayed on its way to a first facility, analyzing the tuning information at step 804 can include determining that a future scheduling decision at a second facility is impacted. The guideline can thus include, for example, information for the second facility to utilize in determining a scheduling decision in view of the delay at the first facility. In some instances, the respective vehicle operator (e.g., via service provider computing device(s)) may enable this capability to allow for enhanced inter-facility scheduling decisions. In other instances, the respective vehicle operator may disable this capacity and remove inter-facility decisions. In yet further instances, the respective vehicle operator may enable this capability for facilities under their control while disabling this capability with respect to outside facilities (owned or operated by another vehicle operator).

The method 800 can further include a step 806 of transmitting the tuning guideline to subscribed facilities (e.g., facilities enabling the capability) to permit scheduling decisions at those subscribed facilities.

In an embodiment, the rule optimizer 500 can be in communication with vehicles (or vehicle operators) and provide instruction to vehicles prior to arriving at the facility. The instructions can include dock assignments, waiting assignments, and other information such as rerouting procedures or the like. The instructions can be updated and retransmitted to the vehicle in view of changes made by the rule optimizer 500. In some instances, the rule optimizer 500 may not trigger transmission of the instructions until such time that the scheduling decision reaches a critical threshold. The critical threshold can include, for example, a time threshold. The time threshold can correspond to an amount of time prior to expected arrival of the vehicle at the facility. For example, the time threshold can be 30 minutes, such that the transmission to the vehicle happens when the vehicle is 30 minutes away from the facility. By way of another example, the critical threshold can include a geographical or distance threshold, such as within a 10 mile radius or within a prescribed geofenced area. Once the vehicle is determined to be within the geofenced or radiused area, the instructions can be transmitted to the vehicle.

Referring now to FIG. 9, a loading dock area 200 (which may correspond to a loading dock 14 of FIG. 1) includes a dock door operator 202 that is configured to be operatively connected to a loading dock door 204 to move the loading dock door 204 between a closed position and an open position. The loading dock door 204 shown in FIG. 9 is in the form of a roller door. In other aspects, the loading dock door 204 may be in the form of a paneled door, a swinging door, a gate, or other suitable barrier for controlling access to an interior 206 of the loading dock area 200.

The dock door operator 202 may include components that are similar to the components of the movable barrier operator 40 discussed with respect to FIG. 2. For example, the dock door operator 202 includes a motor, communication circuitry, a memory, and a processor. The dock door operator 202 is configured to communicate via communication circuitry thereof with the remote server computer 50 over the network 52.

The loading dock area 200 may include one or more loading dock components, indicated generally at 210. Example loading dock components 210 include a photo beam system 220 including an emitter 222, a safety edging of the door 204, a dock leveler 224, a vehicle restraint 226 (e.g., a trailer lock), an exterior camera 228, an interior camera 230, edge guards or dock seal 232, dock bumper 234, an optical detector 236 (e.g., a camera or light time-of-flight sensor), a sensor 238 (e.g., a passive infrared (PIR), ultrasonic, and/or microwave sensor), and a loop detector 240. One or more of the loading dock components 210 may be in communication (e.g., wired or wireless communication) with one or both of the dock door operator 202 and a gateway device 250. The gateway device 250 may be a communications hub that is in communication with the various loading dock components 210 and one or both of the dock door operator 202 and the remote server computer 50, but is not configured to move the loading dock door 204.

In one embodiment, the remote server computer 50 may send a control command to the dock door operator 202 and/or the gateway device 250 to configure at least one component of the loading dock components 210 to facilitate receiving the vehicle 20 at the loading dock area 200. Such a control or configuration command may be issued, for example, upon the conclusion of one or both of the check-in process and the presence verification process, and/or upon the remote server computer 50 causing the movable barrier operator 40 to move the movable barrier 32.

The one or more of the loading dock components 210 may be configured based at least in part on at least one characteristic of the vehicle 20. In one example, the remote server computer 50 may communicate a control command to cause a height adjustment of the dock leveler 224. The height adjustment may be based on a known height of a floor of the trailer associated with the vehicle 20 (e.g., as indicated by the check-in communication 130). In this way, the dock leveler 224 may provide an appropriate transition from a floor of the interior 206 of the loading dock area 200 to the load space associated with the vehicle 20. In still another example, the remote server computer 50 may communicate a control command to cause an adjustment of the operation of the vehicle restraint 226, such as adjusting an orientation of a vehicle restraint hook or adjusting automated wheel chocks. As an example, the control command may cause an actuator to shift a carriage of the vehicle restraint 226 up or down along a vertical track of the vehicle restraint 226. When the carriage has been shifted to the height requested by the control command, the hook of the vehicle restraint 226 is positioned to pivot up and over the rear impact guard of the vehicle 20 to secure the vehicle 20 at the loading dock.

Upon the vehicle 20 arriving at the particular loading dock area 200, a “dock arrival” process is performed. More particularly, the remote server computer 50 may receive (e.g., at the communication interface 90) a dock arrival communication 260 from the user device 24 indicating arrival of the vehicle 20 at the particular loading dock area 200. In one embodiment, the dock arrival communication 260 is transmitted when a vehicle occupant opens and/or controls an application of the user device 24 via the user input 100 (e.g., via a touch screen). In this way, the vehicle occupant may manually effect transmission of the dock arrival communication 260 from the user device 24 upon arriving at the loading dock area 200. According to another aspect, the user device 24 may automatically effect transmission of the dock arrival communication 260. In this aspect, transmission of the dock arrival communication 260 may be effected in response to the processor circuit 118 determining (e.g., via location circuitry 112) that the user device 24 is at a predetermined geolocation or proximity relative to the loading dock area 200 (e.g., proximate the loading dock door 204). In one approach, the dock arrival communication 260 is communicated to the remote server computer 50 via the network 52. In another approach, the dock arrival communication 260 is communicated to the dock door operator 202 and/or the gateway device 250 for communication to the remote server computer 50 via the network 52.

Upon receiving the dock arrival communication 260, the remote server computer 50 may perform a dock presence verification process. More particularly, the remote server computer 50 may communicate (e.g., via the communication interface 90) with one or more devices at the loading dock area 200 to verify the vehicle 20 has arrived at the loading dock area 200.

In one aspect, the remote server computer 50 may communicate with the dock door operator 202 for verification of vehicle presence at the loading dock area 200. The dock door operator 202 and/or the gateway deice 250 may be informed of a presence of the vehicle 20 at the loading dock area 200 through various approaches. In one approach, the dock door operator 202 and/or the gateway device 250 communicates with one or more of the loading dock components 210.

In one example, verification of the presence of the vehicle 20 may include detecting a break in an optical beam transmitted by a photo beam system 220. In another example, verification of the presence of the vehicle 20 may include detecting a change in the base frequency of the electrical signal transmitted by the loop detector 240. Other sensors and loading dock components 210, discussed above, may be used for detecting the presence of the vehicle 20 at the loading dock area 200.

In another approach, the dock door operator 202 is configured to directly detect a presence of a vehicle 20 at the loading dock area 200. For example, the communication circuitry of the dock door operator 202 may communicate with the user device 24, as indicated at signal 262. Such communication may be, for example, via a short-range protocol (e.g., Bluetooth).

As such, at least one of the dock door operator 202 and the gateway device 250 is informed of a presence (or absence as informed or inferred) of a vehicle 20 at the loading dock area 200. In one aspect, the dock door operator 202 is configured to transmit a dock verification communication 264 to the remote server computer 50. The dock verification communication 264 may be transmitted in response to, for example, the dock door operator 202 receiving a presence indication from a loading dock component 210 or the user device 24, or in response to receiving a signal 266 from the gateway device 250. Additionally or alternatively, the gateway device 250 may transmit a dock verification communication 268 to the remote server computer 50.

In still another aspect, one or more of the loading dock components 210 may communicate a verification communication to the remote server computer 50 independently of the dock door operator 202 and gateway device 250 (e.g., via the network 52). In this way, a loading dock component 210 may include a wired or wireless network interface.

In one approach, a loading dock component 210 may continuously or periodically monitor for the presence of a vehicle 20. In another approach, the loading dock component 210 may enter a “sleep” mode, and may check for the presence of a vehicle 20 in response to a “wake” signal transmitted from the dock door operator 202, the gateway device 250, the remote server computer 50 (e.g., as part of the presence verification process), and/or the user device 24. For example, the dock door operator 202 or gateway device 250 may be configured to transmit a wake signal to the loading dock component 210 in response to receiving a vehicle presence query from the remote server computer 50.

The various approaches described herein allow for the remote server computer 50 to be informed of a presence of a vehicle 20 at the loading dock area 200. Upon the remote server computer 50 receiving the dock arrival communication 260 from the user device 24 and a dock verification communication 264 from the dock door operator 202 and/or a dock verification communication 268 from the gateway device 250, the remote server computer 50 may be configured to cause the dock door operator 202 to move the loading dock door 204 from a closed position to an open position whereby access to the interior 206 of the loading dock area 200 is achieved. The remote server computer 50 may cause the dock door operator 202 to move the loading dock door 204 by communicating a control command to the dock door operator 202. Furthermore, the remote server computer 50 may receive, from the dock door operator 202, an indication of the dock door operator 202 moving the loading dock door 204 between closed and open positions. The “open time,” which corresponds to the dock door operator 202 moving the loading dock door 204 between a closed and an open position, may be stored in a memory at one or both of the dock door operator 202 (memory 72) and the remote server computer 50 (memory 92). The open time recorded for the operation of the dock door operator 202 may be utilized as an electronic signature that permits the system 5 to independently verify the vehicle 20 is at the loading dock 14.

In one approach, the remote server computer 50 may further be configured to store, in the memory 92, a “close time” that corresponds to the dock door operator 202 moving the loading dock door 204 between an open and a closed position. The close time may be indicative of the vehicle 20 leaving the loading dock area 200. Furthermore, the remote server computer 50 may be configured to store, in the memory 92, a “departure time” that corresponds to the movable barrier operator 40 moving the movable barrier 32 of the facility 10 between a closed position and an open position to permit the vehicle 20 to exit the facility 10. The departure time may be indicative of the vehicle 20 leaving the facility 10 via the movable barrier 32 and may provide an electronic signature the system 5 may use to independently track movement of the vehicle 20 and freight therein. In this way, arrival, duration of stay, and departure times for a particular vehicle 20 or particular freight transport may be logged and maintained. Such information may be informative of the shipping/receiving performance of the facility and/or timeliness/efficiency of the transportation carrier or vehicle driver/operator, and useful at least in part to determine whether fees or charges are to be assessed e.g. for detention, etc.

As part of the check out process, the remote server computer 50 may initiate freight billing and/or initiate a completed bill of lading. The check out process may involve providing freight information, such as a new or updated bill of lading, for the products loaded onto the vehicle 20 at the facility 10 to the remote server computer 50 and/or user device 24. The new freight information is associated with the user's profile until the user has delivered the freight to the assigned facility. Alternatively or additionally, the check out process may involve the remote server computer 50 generating a notification that the driver is available to pickup a new freight load.

In one aspect, the remote server computer 50 may transmit one or more notifications to a computing device (e.g., a desktop, laptop, smartphone, or tablet) at the facility 10 reporting the activity of the vehicle 20 or various components of the facility 10. Such reporting notifications may be transmitted during the “check-in” process and/or during the “dock arrival” process. For example, the remote server computer 50 may transmit reporting notifications in response to receiving the check-in communication 130 (such that personnel at the facility 10 are notified of the arrival of the vehicle 20 at the movable barrier 32), in response to receiving the verification communication 140, 140′, in response to commanding the movable barrier operator 40 to move the movable barrier 32, and/or in response to a sensor 60 confirming the vehicle has entered the secured premises 16. The remote server computer 50 may also or may instead transmit reporting notifications in response to receiving the dock arrival communication 260 (such that personnel at the facility 10 are notified of the arrival of the vehicle 20 at the loading dock area 200), in response to receiving a dock verification communication 264, 268, and/or in response to commanding the dock door operator 202 to move the loading dock door 204.

Further aspects of the invention are provided by one or more of the following embodiments:

Embodiment 1. A rules optimizer for optimizing one or more operations at a facility, the rules optimizer comprising: a non-transitory computer-readable storage medium storing machine-executable instructions; and a processor in communication with the computer-readable storage medium, wherein the instructions, when executed by the processor, are configured to cause the rules optimizer to: receive an event update associated with an upcoming operation scheduled at the facility; generate a set of potential scheduling decisions associated with the upcoming operation, wherein generating the set of potential scheduling decisions is based at least in part on historical data stored at the non-transitory computer-readable storage medium, and wherein generating the set of potential scheduling decisions is based at least in part on the received event update; select a scheduling decision from the set of potential scheduling decisions; update a schedule associated with the facility in view of the selected scheduling decision; and transmit a notification to a vehicle providing information associated with the updated schedule, the vehicle adjusting an action in response to the updated schedule.

Embodiment 2. The rules optimizer of embodiment 1, wherein the rules optimizer is configured to assign a weight to each potential scheduling decision of the set of potential scheduling decisions, and wherein selecting the scheduling decision from the set of potential scheduling decisions is based at least in part on the assigned weight to each potential scheduling decision of the set of potential scheduling decisions.

Embodiment 3. The rules optimizer of embodiment 2, wherein the assigned weights are affected by a prioritizer of the rules optimizer, the prioritizer including two or more prioritizing schemes that are selectable to affect the assigned weights.

Embodiment 4. The rules optimizer of embodiment 3, wherein the two or more prioritizing schemes are each configured to receive a relative weighting, the relative weighting of the two or more prioritizing schemes equaling 100% weighting.

Embodiment 5. The rules optimizer of any one of embodiments 1 to 4, wherein the processor is further configured to cause the rules optimizer to enter a retraining mode based on the selected scheduling decision.

Embodiment 6. The rules optimizer of any one of embodiments 1 to 5, wherein the rules optimizer is configured to generate the set of potential scheduling decisions in response to receiving the event update.

Embodiment 7. The rules optimizer of any one of embodiments 1 to 6, wherein the rules optimizer is configured to perform a scheduling assistance update at predetermined time intervals, and wherein generating the set of potential scheduling decisions is done during the scheduling assistance update in view of one or more event updates received after the previous scheduling assistance update.

Embodiment 8. The rules optimizer of any one of embodiments 1 to 7, wherein the rules optimizer is configured to receive an updated event update associated with the upcoming operation, wherein the rules optimizer is configured to generate a set of updated potential scheduling decisions associated with the upcoming operation based at least in part on the updated event update, and wherein the rules optimizer is configured to select an updated scheduling decision from the set of updated potential scheduling decisions.

Embodiment 9. The rules optimizer of any one of embodiments 1 to 8, wherein selecting the scheduling decision from the set of potential scheduling decisions comprises scoring each scheduling decision from the set of potential scheduling decisions, and selecting a highest scoring scheduling decision.

Embodiment 10. A computer-implemented method for optimizing one or more operations at a facility, the method comprising: receiving, at a processor of a rules optimizer, an event update associated with an upcoming operation scheduled at the facility, the upcoming operation including a loading or unloading operation associated with freight at a first vehicle; generating, by the processor, a set of potential scheduling decisions associated with the upcoming operation, wherein generating the set of potential scheduling decisions is based at least in part on historical data stored at a non-transitory computer-readable storage medium in communication with the processor, and wherein generating the set of potential scheduling decisions is based at least in part on the received event update; selecting a scheduling decision from the set of potential scheduling decisions, wherein selecting the scheduling decision comprises: scoring each scheduling decision from the set of potential scheduling decisions; and selecting a highest scoring scheduling decision; and updating a schedule associated with the facility in view of the selected scheduling decision; and transmitting a notification to a vehicle providing information associated with the updated schedule, the vehicle adjusting an action in response to the updated schedule.

Embodiment 11. The method of embodiment 10, wherein the scoring is performed by assigning a weight to each of the scheduling decisions, and wherein the weights are affected by a prioritizer of the rules optimizer, the prioritizer including two or more prioritizing schemes that are selectable to affect the assigned weights.

Embodiment 12. The method of embodiment 11, wherein the two or more prioritizing schemes are each configured to receive a relative weighting, the relative weighting of the two or more prioritizing schemes equaling 100% weighting.

Embodiment 13. The method of any one of embodiments 10 to 12, wherein the method further comprises entering a retraining mode.

Embodiment 14. The method of embodiment 13, wherein the entering the retraining mode occurs periodically.

Embodiment 15. The method of any one of embodiments 10 to 14, wherein the method generates the set of potential scheduling decisions in response to receiving the event update.

Embodiment 16. The method of any one of embodiments 10 to 15, wherein the method comprises performing a scheduling assistance update at predetermined time intervals, and wherein generating the set of potential scheduling decisions is done during the scheduling assistance update in view of one or more event updates received since the previous scheduling assistance update.

Embodiment 17. The method of any one of embodiments 10 to 16, wherein updating the schedule comprises moving a previously-scheduled operation associated with a second vehicle.

Embodiment 18. The method of embodiment 17, wherein the method further comprises generating, by the processor, a set of potential scheduling decisions associated with the previously-scheduled operation in view of being moved, selecting a scheduling decision from the set of potential scheduling decisions, and updating the schedule associated with the facility in view of the selected scheduling decision.

Embodiment 19. The method of any one of embodiments 10 to 18, wherein scoring each scheduling decision comprises querying a model to obtain forecasted information and/or availability information that can be used to evaluate an objective function associated with the facility.

Embodiment 20. The method of any one of embodiments 10 to 19, wherein the historical data is updated to include information associated with the event update.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A rules optimizer for optimizing one or more operations at a facility, the rules optimizer comprising:
a non-transitory computer-readable storage medium storing machine-executable instructions; and
a processor in communication with the computer-readable storage medium, wherein the instructions, when executed by the processor, are configured to cause the rules optimizer to:
receive an event update associated with an upcoming operation scheduled at the facility;
generate a set of potential scheduling decisions associated with the upcoming operation, wherein generating the set of potential scheduling decisions is based at least in part on historical data stored at the non-transitory computer-readable storage medium, and wherein generating the set of potential scheduling decisions is based at least in part on the received event update;
select a scheduling decision from the set of potential scheduling decisions;
update a schedule associated with the facility in view of the selected scheduling decision; and
transmit a notification to a vehicle providing information associated with the updated schedule, the vehicle adjusting an action in response to the updated schedule.

2. The rules optimizer of claim 1, wherein the rules optimizer is configured to assign a weight to each potential scheduling decision of the set of potential scheduling decisions, and wherein selecting the scheduling decision from the set of potential scheduling decisions is based at least in part on the assigned weight to each potential scheduling decision of the set of potential scheduling decisions.

3. The rules optimizer of claim 2, wherein the assigned weights are affected by a prioritizer of the rules optimizer, the prioritizer including two or more prioritizing schemes that are selectable to affect the assigned weights.

4. The rules optimizer of claim 3, wherein the two or more prioritizing schemes are each configured to receive a relative weighting, the relative weighting of the two or more prioritizing schemes equaling 100% weighting.

5. The rules optimizer of claim 1, wherein the processor is further configured to cause the rules optimizer to enter a retraining mode based on the selected scheduling decision.

6. The rules optimizer of claim 1, wherein the rules optimizer is configured to generate the set of potential scheduling decisions in response to receiving the event update.

7. The rules optimizer of claim 1, wherein the rules optimizer is configured to perform a scheduling assistance update at predetermined time intervals, and wherein generating the set of potential scheduling decisions is done during the scheduling assistance update in view of one or more event updates received after the previous scheduling assistance update.

8. The rules optimizer of claim 1, wherein the rules optimizer is configured to receive an updated event update associated with the upcoming operation, wherein the rules optimizer is configured to generate a set of updated potential scheduling decisions associated with the upcoming operation based at least in part on the updated event update, and wherein the rules optimizer is configured to select an updated scheduling decision from the set of updated potential scheduling decisions.

9. The rules optimizer of claim 1, wherein selecting the scheduling decision from the set of potential scheduling decisions comprises scoring each scheduling decision from the set of potential scheduling decisions, and selecting a highest scoring scheduling decision.

10. A computer-implemented method for optimizing one or more operations at a facility, the method comprising:
receiving, at a processor of a rules optimizer, an event update associated with an upcoming operation scheduled at the facility, the upcoming operation including a loading or unloading operation associated with freight at a first vehicle;
generating, by the processor, a set of potential scheduling decisions associated with the upcoming operation, wherein generating the set of potential scheduling decisions is based at least in part on historical data stored at a non-transitory computer-readable storage medium in communication with the processor, and wherein generating the set of potential scheduling decisions is based at least in part on the received event update;
selecting a scheduling decision from the set of potential scheduling decisions, wherein selecting the scheduling decision comprises:
scoring each scheduling decision from the set of potential scheduling decisions; and
selecting a highest scoring scheduling decision; and
updating a schedule associated with the facility in view of the selected scheduling decision; and
transmitting a notification to a vehicle providing information associated with the updated schedule, the vehicle adjusting an action in response to the updated schedule.

11. The method of claim 10, wherein the scoring is performed by assigning a weight to each of the scheduling decisions, and wherein the weights are affected by a prioritizer of the rules optimizer, the prioritizer including two or more prioritizing schemes that are selectable to affect the assigned weights.

12. The method of claim 11, wherein the two or more prioritizing schemes are each configured to receive a relative weighting, the relative weighting of the two or more prioritizing schemes equaling 100% weighting.

13. The method of claim 10, wherein the method further comprises entering a retraining mode.

14. The method of claim 13, wherein the entering the retraining mode occurs periodically.

15. The method of claim 10, wherein the method generates the set of potential scheduling decisions in response to receiving the event update.

16. The method of claim 10, wherein the method comprises performing a scheduling assistance update at predetermined time intervals, and wherein generating the set of potential scheduling decisions is done during the scheduling assistance update in view of one or more event updates received since the previous scheduling assistance update.

17. The method of claim 10, wherein updating the schedule comprises moving a previously-scheduled operation associated with a second vehicle.

18. The method of claim 17, wherein the method further comprises generating, by the processor, a set of potential scheduling decisions associated with the previously-scheduled operation in view of being moved, selecting a scheduling decision from the set of potential scheduling decisions, and updating the schedule associated with the facility in view of the selected scheduling decision.

19. The method of claim 10, wherein scoring each scheduling decision comprises querying a model to obtain forecasted information and/or availability information that can be used to evaluate an objective function associated with the facility.

20. The method of claim 10, wherein the historical data is updated to include information associated with the event update.
